(19) United States
(12) Patent Application Publication
(10) Pub. No.: US 2026/0105700 A1
(43) Pub. Date: Apr. 16, 2026

(54) INFORMATION PROCESSING APPARATUS AND INFORMATION PROCESSING METHOD

(71) Applicant: SONY GROUP CORPORATION, Tokyo (JP)

(72) Inventors: Yohei FUKUMA, Chiba (JP); Hiroshi YUASA, Kanagawa (JP); Tsuyoshi ISHIKAWA, Kanagawa (JP); Ikuo YAMANO, Tokyo (JP); Masafumi YONEDA, Tokyo (JP); Yuri ISHIKAWA, Kanagawa (JP)

(73) Assignee: SONY GROUP CORPORATION, Tokyo (JP)

(21) Appl. No.: 19/116,369

(22) PCT Filed: Oct. 18, 2023
(86) PCT No.: PCT/JP2023/037649

§ 371 Date: Mar. 28, 2025

Related U.S. Application Data
(60) Provisional application No. 63/418,782, filed on Oct. 24, 2022.

(51) Int. Cl. G06T 19/00; G06F 3/01; G06V 20/20

(52) U.S. Cl. CPC G06T 19/006; G06F 3/014; G06V 20/20; G06T 2200/24

(57) ABSTRACT

There is provided an information processing apparatus and an information processing method capable of easily designating a virtual object in an XR (cross reality) space. The information processing apparatus includes: a space control unit that controls display of a virtual object in an XR space; and a recognition unit that recognizes a designated object that is the virtual object designated by a user on the basis of a position, a posture, and a degree of opening of a virtual tool or a real input device capable of adjusting a degree of opening of tips in the XR space. The present technology can be applied to, for example, an XR system.

### TECHNICAL FIELD

The present technology relates to an information processing apparatus and an information processing method, and more particularly, to an information processing apparatus and an information processing method capable of easily designating a virtual object in an XR (cross reality) space.

### BACKGROUND ART

Conventionally, a technique of selecting and moving a virtual object (virtual article) in a virtual space using a tweezers type operating device has been proposed (see, for example, Patent Document 1).

### CITATION LIST

### Patent Document

Patent Document 1: Japanese Patent Application Laid-Open No. 2010-20526.

### SUMMARY OF THE INVENTION

### Problems to be Solved by the Invention

However, in the invention described in Patent document 1, for example, in a case where virtual objects are densely arranged in a virtual space, it is assumed that it becomes difficult to select a desired virtual object.

The present technology has been made in view of such a situation, and makes it possible to easily designate a virtual object in the XR space.

### Solutions to Problems

An information processing apparatus according to one aspect of the present technology includes: a space control unit that controls display of a virtual object in an XR space; and a recognition unit that recognizes a designated object that is the virtual object designated by a user on the basis of a position, a posture, and a degree of opening of a virtual tool or a real input device capable of adjusting a degree of opening of tips in the XR space.

An information processing method according to one aspect of the present technology includes, by an information processing apparatus: controlling display of a virtual object in an XR space; and recognizing a designated object that is the virtual object designated by a user on the basis of a position, a posture, and a degree of opening of a virtual tool or a real input device capable of adjusting a degree of opening of tips in the XR space.

In one aspect of the present technology, display of a virtual object in an XR space is controlled, and a designated object that is the virtual object designated by a user is recognized on the basis of a position, a posture, and a degree of opening of a virtual tool or a real input device capable of adjusting a degree of opening of tips in the XR space.

### BRIEF DESCRIPTION OF DRAWINGS

FIG. 1 is a diagram illustrating an embodiment of an XR system to which the present technology is applied.

FIG. 2 is a diagram illustrating a display example of the XR system.

FIG. 3 is a diagram illustrating a display example of the XR system.

FIG. 4 is a block diagram illustrating a configuration example of an information processing apparatus and a terminal device.

FIG. 5 is an external diagram illustrating a configuration example of a controller device.

FIG. 6 is a diagram illustrating a method of gripping the controller device.

FIG. 7 is a diagram illustrating a method of gripping the controller device.

FIG. 8 is a diagram illustrating a method of gripping the controller device.

FIG. 9 is a diagram illustrating an arrangement example of operation members of the controller device.

FIG. 10 is a diagram illustrating an arrangement example of markers of the controller device.

FIG. 11 is a diagram illustrating an example of how the markers of the controller device are seen.

FIG. 12 is a diagram for explaining a method of recognizing a position and a posture of the controller device.

FIG. 13 is a diagram illustrating an example of an internal configuration of the controller device.

FIG. 14 is a diagram illustrating an arrangement example of tactile devices of the controller device.

FIG. 15 is a flowchart for explaining operation member control processing executed by the XR system.

FIG. 16 is a diagram for explaining the operation member control processing executed by the XR system.

FIG. 17 is a diagram illustrating an example of a method of gripping the controller device.

FIG. 18 is a diagram illustrating an example of a method of gripping the controller device.

FIG. 19 is a diagram illustrating an example of a method of gripping the controller device.

FIG. 20 is a flowchart for explaining tactile feedback control processing executed by the XR system.

FIG. 21 is a diagram for explaining an example of tactile feedback.

FIG. 22 is a diagram for explaining an example of tactile feedback.

FIG. 23 is a diagram for explaining an example of tactile feedback.

FIG. 24 is a flowchart for explaining a first embodiment of component designation processing.

FIG. 25 is a diagram illustrating an example of a virtual tool.

FIG. 26 is a diagram for explaining a method of operating the virtual tool.

FIG. 27 is a diagram illustrating a display example of a designation candidate component.

FIG. 28 is a diagram illustrating a display example of a designation candidate component.

FIG. 29 is a diagram illustrating a display example of a designation candidate component.

FIG. 30 is a flowchart for explaining a second embodiment of component designation processing.

FIG. 31 is an external diagram illustrating a configuration example of a controller device.

FIG. 32 is a diagram for explaining learning processing of the degree of opening of fingers.

FIG. 33 is a block diagram illustrating a configuration example of a computer.

### MODE FOR CARRYING OUT THE INVENTION

Hereinafter, modes for carrying out the present technology will be described. The description will be given in the following order.
1. Embodiment
2. Modifications
3. Others

### 1. Embodiment

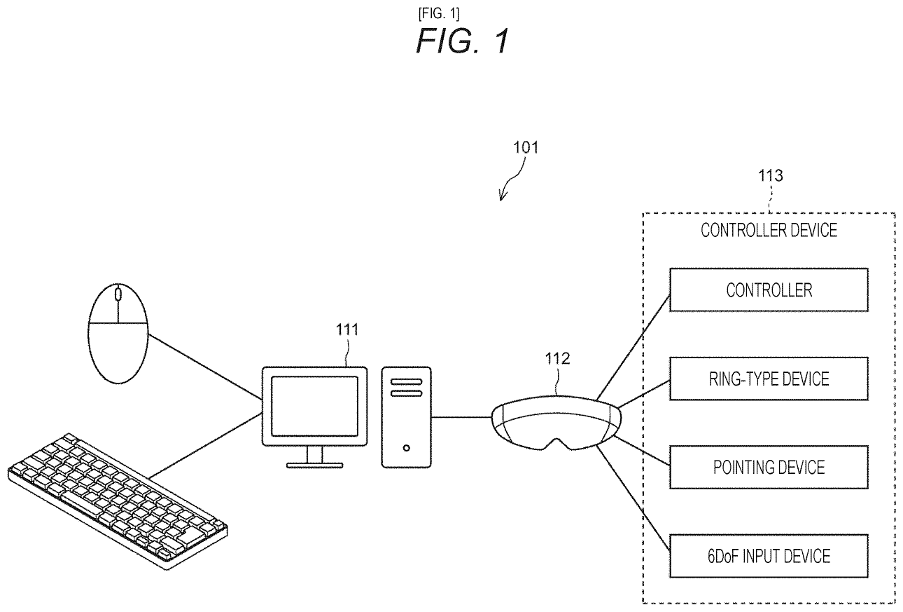

Embodiment of the present technology will be described with reference to FIGS. 1 to 30.

### <Configuration Example of XR System 101>

FIG. 1 illustrates a configuration example of an XR (cross reality) system 101 which is an embodiment of an information processing system to which the present technology is applied.

The XR system 101 is a system that realizes XR that is a technology of fusing a real world and a virtual world, such as virtual reality (VR), augmented reality (AR), mixed reality (MR), and alternative reality (SR). The XR system 101 is a system that presents a space (hereinafter, referred to as an XR space) obtained by fusing a real space and a virtual space to a user. For example, the XR system 101 can present an object which is virtual (hereinafter, referred to as a virtual object or a virtual article) that is not real, such as a model created by computer aided design (CAD) (hereinafter, referred to as a CAD model), to the user as if the virtual object was present on the spot.

The XR system 101 includes an information processing apparatus 111, a terminal device 112, and a controller device 113.

The information processing apparatus 111 and the terminal device 112 can communicate with each other wirelessly or by wire, and transmit and receive data to and from each other. The terminal device 112 and the controller device 113 can communicate with each other wirelessly or by wire, and transmit and receive data to and from each other. The information processing apparatus 111 and the controller device 113 communicate with each other via the terminal device 112, and transmit and receive data to and from each other.

For example, the information processing apparatus 111 can independently receive an operation by the user and present various types of information such as visual information and auditory information to the user.

Furthermore, the information processing apparatus 111 controls the terminal device 112 and controls presentation of the XR space to the user by the terminal device 112, for example, by executing a predetermined application (hereinafter, referred to as an XR application). For example, the information processing apparatus 111 executes the XR application to control output of various types of information such as visual information and auditory information in the terminal device 112, and constructs the XR space presented by the terminal device 112.

FIG. 1 illustrates an example in which the information processing apparatus 111 includes a personal computer (PC) including an operation input unit including a mouse and a keyboard. For example, the information processing apparatus 111 may include another information processing apparatus such as a smartphone or a tablet terminal. For example, the information processing apparatus 111 may include a plurality of information processing apparatuses. For example, the information processing apparatus 111 may be configured by a system constructed by cloud computing via a network.

The terminal device 112 is a device that presents the XR space to the user.

FIG. 1 illustrates an example in which the terminal device 112 is a head mounted display device that can be mounted on the head of the user and includes a head mounted display (HMD) that is a device that presents the XR space to the user. More specifically, an example in which the terminal device 112 is a non-transmissive HMD that covers the user's field of view is illustrated.

For example, the terminal device 112 includes a video see-through type HMD that has an imaging function capable of imaging a real space on the basis of the viewpoint of the user and is capable of presenting, to the user, a combined image obtained by combining a real image obtained by imaging the real space and an image (hereinafter, referred to as a virtual image) of a virtual space such as computer graphics (CG).

For example, the terminal device 112 includes left and right imaging units respectively corresponding to the left and right eyes of the user, and left and right display units respectively corresponding to the left and right eyes of the user.

For example, the left and right imaging units constitute a stereo camera, and capture images (hereinafter, referred to as a visual field image) in the line-of-sight direction of the user from a plurality of viewpoints corresponding to the left and right eyes of the user. That is, the left and right imaging units capture images of objects (hereinafter, referred to as a real object or a real article) in the real space viewed from the user's viewpoint.

The left and right display units can display different images for the left and right eyes, respectively, and can present a three-dimensional virtual object by displaying images with parallax for the left and right eyes. For example, the left and right display units respectively display left and right visual field images captured by the left and right imaging units.

Note that the terminal device 112 may include, for example, another terminal device for XR such as a smartphone used by being set in AR glasses or goggles. Furthermore, for example, a display device such as a spatial reproduction display may be used instead of the terminal device 112.

The controller device 113 is used for an operation and an input (hereinafter, referred to as an operation input) with respect to the XR space presented to the user by the terminal device 112. For example, the user can perform various operations on the virtual object displayed by the terminal device 112 using the controller device 113.

For example, the controller device 113 detects at least one of an operation input by the user and a behavior of the user (for example, a gesture) by at least one of an operation member such as a button and a sensor. The controller device 113 transmits a signal (hereinafter, referred to as a controller signal) including at least one of an operation input signal indicating an operation input of the user and a behavior signal indicating a behavior of the user to the information processing apparatus 111 via the terminal device 112.

Furthermore, for example, the controller device 113a includes a tactile device that presents a tactile stimulation such as vibration, and presents the tactile stimulation to the user under the control of the information processing apparatus 111 or the terminal device 112.

The controller device 113 includes, for example, one or more types of input devices among a controller, a ring type input device, a pointing device, and a 6DoF (six degrees of freedom) input device.

The controller is, for example, an input device gripped by a hand of the user. The controller may include, for example, an operation member such as a button operable by a user. For example, the user can perform a selection operation, a determination operation, a scroll operation, and the like on the virtual object displayed on the terminal device 112 by pressing a button of the controller. Furthermore, the controller may include, for example, a touch sensor and a motion sensor.

Note that the controller is not limited to being gripped by the hand of the user, and may be worn on a part of the user's body such as an elbow, an arm, a knee, an ankle, or a thigh.

The ring-type device is a ring-type input device worn on a finger of a user. The ring-type device may include, for example, an operation member such as a button that can be operated by the user. For example, the user can change the position and posture of the virtual object (for example, a three-dimensional model) in the XR space by 6DoF (six degrees of freedom) by operating the ring-type device.

The pointing device is an input device capable of indicating an arbitrary position in the XR space. For example, the position and posture of 6DoF of the pointing device are recognized by the information processing apparatus 111 via the terminal device 112 by a tracking method such as a bright spot tracking method, a porcelain tracking method, or an ultrasonic tracking method.

The 6DoF input device is, for example, an input device capable of operating 6DoF.

For example, the user can perform an operation input on the controller device 113 while viewing various objects (display objects) displayed on the information processing apparatus 111 or the terminal device 112.

Note that the type and number of the controller devices 113 are not particularly limited. For example, as the controller device 113, an input device other than the above-described types may be used, or an input device obtained by combining a plurality of types of input devices may be used.

For example, the XR system 101 can be applied to various fields such as a manufacturing field and a medical field.

For example, the XR system 101 can perform product design support and assembly support in the manufacturing field. For example, in a product design stage, the user can freely edit a three-dimensional object, which is a virtual object, by using the XR system 101, or can grasp a design result and a design in advance before trial production by comparing with the real world.

For example, the XR system 101 can support surgery and education in the medical field. For example, using the XR system 101, the user can display the state in the body on the body surface of the patient to grasp the operation site or perform training in advance.

Note that, for example, in a case where the XR space is shared by a plurality of users, for example, in the XR system 101, the terminal device 112 and the controller device 113 are provided for each user.

### <Display Example of XR System 101>

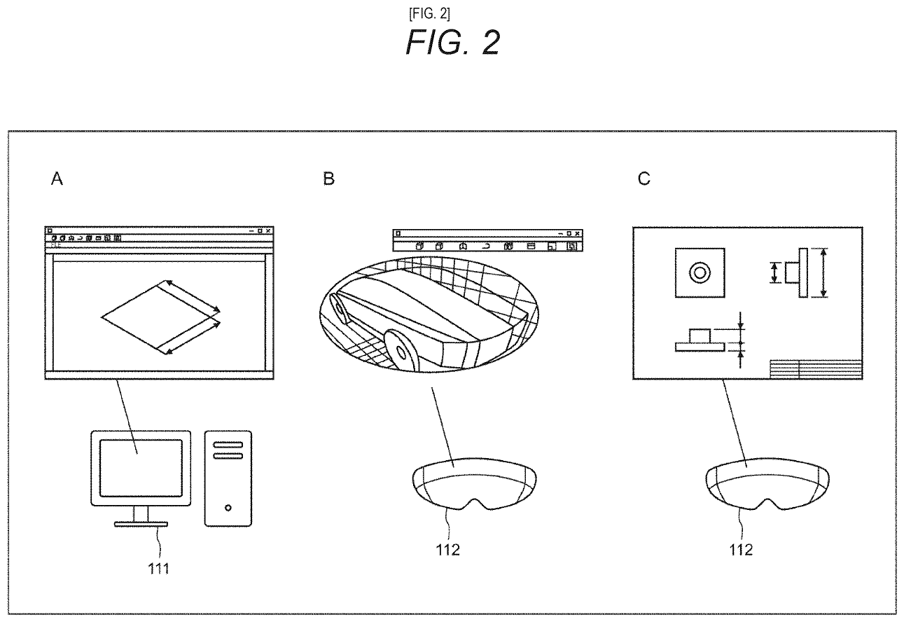

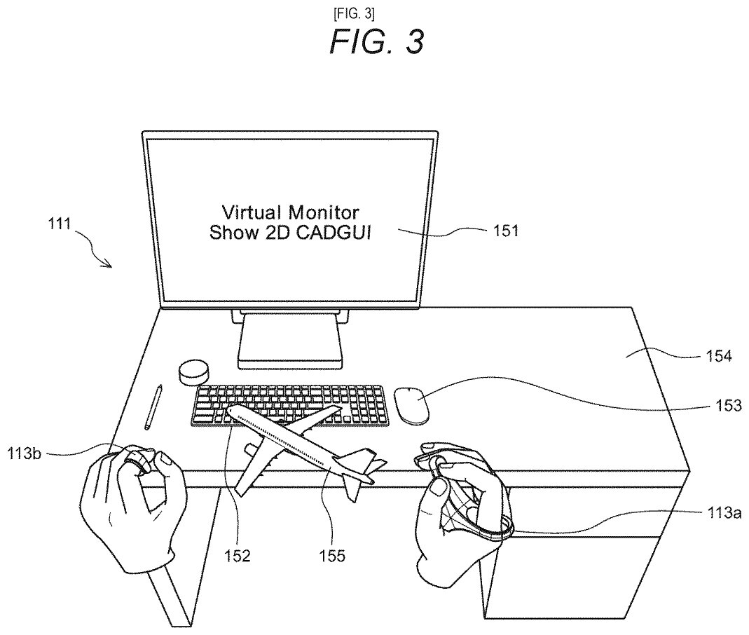

Here, a display example of the display object in the XR system 101 will be described with reference to FIGS. 2 and 3.

FIGS. 2 and 3 illustrate display examples of display objects in the XR system 101 in a case where a CAD model is created.

For example, as illustrated in A of FIG. 2, a two-dimensional CAD model is displayed by the information processing apparatus 111, and the user can edit the two-dimensional CAD model.

For example, as illustrated in B of FIG. 2, a three-dimensional CAD model is displayed by the terminal device 112, and the user can edit the three-dimensional CAD model.

For example, as illustrated in C of FIG. 2, a two-dimensional object such as a design drawing or a specification is displayed by the terminal device 112, and the user can confirm the design drawing, the specification, or the like.

FIG. 3 illustrates a display example of the XR space by the terminal device 112.

A display 151, a keyboard 152, a mouse 153, and a desk 154 of the information processing apparatus 111 are displayed as a video see-through by a real image obtained by capturing a real space. On the other hand, a two-dimensional image by the terminal device 112 is superimposed on the display 151 as a virtual monitor. For example, a two-dimensional CAD model to be designed is displayed on the virtual monitor. The two-dimensional CAD model displayed by the virtual monitor is preferably operated by the keyboard 152 and the mouse 153, for example, from the viewpoint of high accuracy of position detection and ease of position holding.

Furthermore, in this example, the three-dimensional CAD model 155 to be designed is displayed in front of the display 151 by the terminal device 112.

The CAD model 155 is operated by, for example, the controller device 113a gripped by the user's dominant hand (in this example, the right hand) and the controller device 113b, which is a ring-type device worn on the index finger of the user's non-dominant hand (in this example, the left hand).

For example, the information processing apparatus 111 recognizes the position, posture, and behavior of the hand gripping the controller device 113a and the hand of the user gripping the controller device 113b by executing the hand tracking on the basis of the image captured by the imaging unit included in the terminal device 112. Furthermore, for example, the information processing apparatus 111 receives controller signals from the controller device 113a and the controller device 113b via the terminal device 112, and recognizes operations on the CAD model 155 by the controller device 113a and the controller device 113b on the basis of the controller signals.

For example, the user can grasp, separate, or move and rotate the CAD model 155 in 6DoF using the controller device 113a or the controller device 113b.

Note that, for example, in a case where the controller device 113a or the hand to which the controller device 113b is attached is moved in a state where the CAD model 155 is not grasped, the CAD model 155 may not move, or the CAD model 155 may move so as to move the virtual point.

For example, the user can point at an arbitrary point, line, surface, or the like of the CAD model 155 by a ray (virtual ray) or the like using the controller device 113a. For example, the user can perform line drawing to draw a line on the CAD model 155 using the controller device 113a.

For example, the user can edit (for example, modeling, wiring, disassembly, and the like) the CAD model 155 using the controller device 113a or the controller device 113b.

### <Configuration Examples of Information Processing Apparatus 111 and Terminal Device 112>

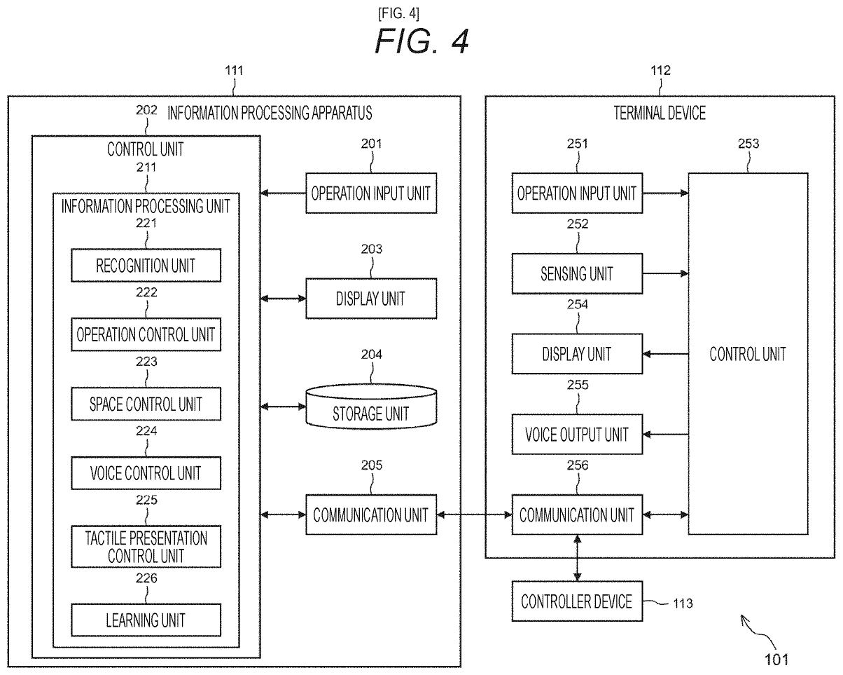

FIG. 4 is a block diagram illustrating a configuration example of functions of the information processing apparatus 111 and the terminal device 112 of the XR system 101.

The information processing apparatus 111 includes an operation input unit 201, a control unit 202, a display unit 203, a storage unit 204, and a communication unit 205.

The operation input unit 201 includes, for example, an input device such as a keyboard and a mouse. The operation input unit 201 receives a user's operation input and supplies an operation input signal indicating the content of the user's operation input to the control unit 202.

The control unit 202 includes, for example, an electronic circuit such as a CPU and a microprocessor. Furthermore, the control unit 202 may include a ROM that stores programs to be used, operation parameters, and the like, and a RAM that temporarily stores parameters and the like that change as appropriate.

For example, the control unit 202 functions as an arithmetic processing device and a control device, and controls the overall operation of the information processing apparatus 111 and executes various pieces of processing according to various programs.

For example, the control unit 202 realizes the information processing unit 211 by executing the information processing apparatus 111 and an XR application capable of user experience in the XR space and editing a virtual object. The information processing unit 211 includes a recognition unit 221, an operation control unit 222, a space control unit 223, a voice control unit 224, a tactile sense presentation control unit 225, and a learning unit 226. That is, the recognition unit 221, the operation control unit 222, the space control unit 223, the voice control unit 224, the tactile sense presentation control unit 225, and the learning unit 226 are implemented by the control unit 202 executing the XR application. Furthermore, input and output of each unit of the information processing unit 211, that is, the recognition unit 221, the operation control unit 222, the space control unit 223, the voice control unit 224, the tactile sense presentation control unit 225, and the learning unit 226 are executed via the XR application.

The recognition unit 221 recognizes a state of the information processing apparatus 111, a state of the terminal device 112, a state around the terminal device 112, a state of the controller device 113, a state of the user, a user operation, a state of the XR space, and the like on the basis of at least one of an operation input signal from the operation input unit 201, information from the control unit 202, information from the display unit 203, information from the communication unit 205, sensing data transmitted from the terminal device 112, a controller signal transmitted from the controller device 113, information from the operation control unit 222, and information from the space control unit 223.

The state of the information processing apparatus 111 to be recognized includes, for example, at least one of a state of each unit of the information processing apparatus 111, a state of each application such as an XR application, a communication state between the information processing apparatus 111 and another apparatus, and various types of setting information (for example, setting values of various setting items, and the like). The state of each unit of the information processing apparatus 111 includes, for example, at least one of an operation state of each unit, presence or absence of abnormality, and a content of the abnormality. The state of each application includes, for example, at least one of start, end, operation state, presence or absence of abnormality, and content of abnormality of each application. The communication state between the information processing apparatus 111 and another apparatus includes, for example, a communication state with the terminal device 112 and a communication state with the controller device 113 via the terminal device 112.

The state of the terminal device 112 to be recognized includes, for example, at least one of the position, posture, and behavior of the terminal device 112 and various types of setting information (for example, setting values of various setting items, and the like). Note that, for example, in a case where the terminal device 112 is worn by the user, the position, posture, and behavior of the terminal device 112 indirectly indicate the position, posture, and behavior of the part of the user wearing the terminal device 112.

The state around the terminal device 112 to be recognized includes, for example, at least one of a type, a position, a posture, a behavior, a size, a shape, an appearance, and a feature amount of a real object around the terminal device 112 (user).

The state of the controller device 113 to be recognized includes, for example, at least one of the position, posture, and behavior of the controller device 113 and various types of setting information (for example, setting values of various setting items, and the like).

The state of the user to be recognized includes, for example, at least one of a position, a posture, an overall behavior, a behavior of a body part, and a line-of-sight direction of the user.

The user operation to be recognized includes, for example, at least one of an operation input by the operation input unit 201, an operation input by the controller device 113, an operation input by a gesture of the user, and an operation input by a virtual tool or the like in the XR space.

The state of the XR space to be recognized includes, for example, at least one of a type, a position, a posture, a behavior, a size, a shape, an appearance, and a feature amount of a virtual object in the XR space.

The recognition unit 221 supplies information regarding the recognition result to each unit of the information processing apparatus 111.

Furthermore, the recognition unit 221 transmits information regarding the recognition result to the terminal device 112 via the communication unit 205, and transmits the information to the controller device 113 via the communication unit 205 and the terminal device 112. For example, in a case of detecting a change or abnormality in the state of the terminal device 112 or the input device 113, the recognition unit 221 transmits information indicating the detected content to the terminal device 112 via the communication unit 205 or transmits the information to the controller device 113 via the communication unit 205 and the terminal device 112. For example, in a case of detecting a change (for example, start, stop, and the like) or abnormality in the state of an application such as an XR application, the recognition unit 221 transmits information indicating the detected content to the terminal device 112 via the communication unit 205, or transmits the information to the controller device 113 via the communication unit 205 and the terminal device 112.

Note that any method such as image recognition or article recognition can be used for the recognition processing of various recognition targets by the recognition unit 221.

Furthermore, for example, in a case where the XR space is shared by a plurality of users, the recognition unit 221 executes recognition processing for each user, for example. For example, the recognition unit 221 recognizes the state of the terminal device 112 of each user, the state around the terminal device 112 of each user, the state of the controller device 113 of each user, the state of each user, and the user operation of each user. The result of the recognition processing for each user may be shared between the users, for example, by being transmitted to the terminal device 112 or the controller device 113 of each user.

The operation control unit 222 controls operation processing by the controller device 113 on the basis of at least one of a recognition result by the recognition unit 221 and a controller signal transmitted from the controller device 113.

For example, the operation control unit 222 controls operation processing by the controller device 113 on the basis of at least one of the position and posture of the controller device 113 and a controller signal. For example, the operation control unit 222 controls enabling or disabling of each operation member included in the controller device 113, a function to be assigned to each operation member, an operation method of a function assigned to each operation member, and the like on the basis of a mounting method, a gripping method, a use method, and the like of the controller device 113.

The operation control unit 222 supplies information regarding control of operation processing by the controller device 113 to each unit of the information processing apparatus 111.

The space control unit 223 controls presentation of the two-dimensional space or the three-dimensional space by the display unit 203 and presentation of the XR space by the terminal device 112 on the basis of at least a part of the recognition result by the recognition unit 221.

For example, the space control unit 223 generates a display object to be displayed in a two-dimensional space or a three-dimensional space on the basis of at least a part of the recognition result by the recognition unit 221, and performs various operations necessary for construction, display, and the like of the two-dimensional space or the three-dimensional space, such as behavior of the display object. The space control unit 223 generates display control information for controlling the display of the two-dimensional space or the three-dimensional space on the basis of the calculation result and supplies the display control information to the display unit 203, thereby controlling the display of the two-dimensional space or the three-dimensional space by the display unit 203. Note that the display control information may include, for example, information for using a two-dimensional space or a three-dimensional space (for example, an operation menu, guidance, a message, and the like), and information for notifying the state of the information processing apparatus 111 (for example, setting information, remaining battery charge, error display, and the like).

For example, the space control unit 223 generates a virtual object to be displayed in the XR space on the basis of at least a part of the recognition result by the recognition unit 221, and performs various operations necessary for construction, display, and the like of the XR space such as behavior of the virtual object. The recognition result by the recognition unit 221 includes, for example, operation content for the controller device 113a recognized by the recognition unit 221 on the basis of a controller signal or the like including an operation input signal from the controller device 113a. The space control unit 223 generates display control information for controlling the display of the XR space on the basis of the calculation result and transmits the display control information to the terminal device 112 via the communication unit 205, thereby controlling the display of the XR space by the terminal device 112. Note that the display control information may include, for example, information for using the XR space (for example, an operation menu, guidance, a message, and the like) and information for notifying the state of the XR system 101 (for example, setting information, remaining battery charge, error display, and the like).

The space control unit 223 supplies information regarding the two-dimensional space, the three-dimensional space, and the XR space to each unit of the information processing apparatus 111.

The voice control unit 224 controls the output of the voice by the terminal device 112 on the basis of at least one of the recognition result by the recognition unit 221 and the information from the space control unit 223. For example, the space control unit 223 generates voice control information for outputting a voice in the terminal device 112. The voice control information includes, for example, information regarding at least one of a type, content, frequency, amplitude, and waveform of sound to be output. The voice control unit 224 controls the output of the voice by the terminal device 112 by transmitting the voice control information to the terminal device 112 via the communication unit 205.

The tactile sense presentation control unit 225 controls presentation of a tactile stimulation to the user on the basis of at least one of a recognition result by the recognition unit 221 and information from the space control unit 223. For example, the tactile sense presentation control unit 225 generates tactile control information for presenting a tactile stimulation in the controller device 113. The tactile control information includes, for example, information regarding at least one of a type, a pattern, strength, and a length of a tactile sensation to be presented. The tactile sense presentation control unit 225 transmits the tactile control information to the controller device 113 via the communication unit 205 and the terminal device 112, thereby controlling presentation of tactile stimulation by the controller device 113.

The learning unit 226 executes learning processing related to processing of the XR system 101 on the basis of at least one of a recognition result by the recognition unit 221 and learning data given from the outside. For example, the learning unit 226 learns the user's taste, action pattern, and the like, and adjusts various pieces of processing and parameters of the XR system 101 on the basis of the learning result so as to appropriately correspond to the user's taste, action pattern, and the like. For example, the learning unit 226 learns the difference between the XR space and the real space, and adjusts the design data and the like on the basis of the learning result so as to bring the characteristics, behavior, and the like of the virtual object in the XR space closer to the real object.

The learning unit 226 stores, for example, information (for example, a learning model or the like) indicating a learning result in the storage unit 204.

Note that the control unit 202 may execute not only the XR application but also other applications.

The storage unit 204 includes, for example, a read only memory (ROM) that stores programs, operation parameters, and the like used for processing of the control unit 202, and a random access memory (RAM) that temporarily stores parameters and the like that change appropriately.

The communication unit 205 communicates with an external device to transmit and receive data. For example, the communication unit 205 communicates with the terminal device 112 to transmit and receive data. For example, the communication unit 205 transmits the display control information, the voice control information, and the tactile control information to the terminal device 112. For example, the communication unit 205 receives sensing data and a controller signal from the terminal device 112.

The communication method of the communication unit 205 may be wired or wireless, and for example, a wired LAN, a wireless LAN, Wi-Fi, Bluetooth, or the like is used. Furthermore, the communication unit 205 may support two or more types of communication methods.

The terminal device 112 includes an operation input unit 251, a sensing unit 252, a control unit 253, a display unit 254, a voice output unit 255, and a learning unit 226.

The operation input unit 251 includes, for example, an operation input device such as a button. The operation input unit 201 receives a user's operation input and supplies an operation input signal indicating the content of the user's operation input to the control unit 253. For example, the operation input unit 251 receives an operation input such as turning on or off the power of the terminal device 112 and adjusting the brightness of the display unit 254 by the user.

The sensing unit 252 includes various sensors for sensing the terminal device 112, the surroundings of the terminal device 112, and the state of the user. For example, the sensing unit 252 includes a camera or a depth sensor for imaging the periphery of the terminal device 112. For example, the sensing unit 252 includes a camera or a depth sensor for imaging both eyes of the user. For example, the sensing unit 252 includes an inertial measurement unit (IMU) for detecting acceleration, angular velocity, and the like of the terminal device 112. For example, the sensing unit 252 includes a global navigation satellite system (GNSS) receiver for detecting the current position of the terminal device 112 (user). The sensing unit 252 supplies sensing data indicating a detection result of at least one or more of the sensors to the control unit 253.

The control unit 253 includes, for example, an electronic circuit such as a CPU and a microprocessor. Furthermore, the control unit 253 may include a ROM that stores programs to be used, operation parameters, and the like, and a RAM that temporarily stores parameters and the like that change as appropriate.

For example, the control unit 253 functions as an arithmetic processing device and a control device, and controls the overall operation of the terminal device 112 and executes various pieces of processing on the basis of an operation input signal from the operation input unit 251, sensing data from the sensing unit 252, display control information and voice control information from the information processing apparatus 111, a controller signal from the controller device 113, and the like according to various programs. For example, the control unit 253 controls display of the XR space or the like by the display unit 254 on the basis of the display control information. For example, the control unit 253 controls output of a voice by the voice output unit 255 on the basis of the voice control information.

The display unit 254 includes various display devices. For example, in a case where the terminal device 112 is an HMD, the display unit 254 includes displays fixed to the left and right eyes of the user, and displays a left-eye image and a right-eye image. The display includes, for example, a display panel such as a liquid crystal display or an organic electro luminescence (EL) display, or a laser scanning display such as a retina direct drawing display. Furthermore, the display unit 254 may include, for example, an imaging optical system that enlarges and projects a display screen and forms an enlarged virtual image having a predetermined angle of view on the user's pupil. For example, the display unit 254 displays the XR space including the virtual object under the control of the control unit 253.

The voice output unit 255 includes, for example, a voice output device such as a headphone, an earphone, or a speaker. The voice output unit 255 outputs a voice under the control of the control unit 253.

The communication unit 256 communicates with an external device to transmit and receive data. For example, the communication unit 256 communicates with the terminal device 112 and the controller device 113 to transmit and receive data. For example, the communication unit 256 transmits sensing data and a controller signal to the information processing apparatus 111. For example, the communication unit 256 receives the display control information, the voice control information, and the tactile control information from the information processing apparatus 111. For example, the communication unit 256 transmits the tactile control information to the controller device 113. For example, the communication unit 256 receives a controller signal from the controller device 113.

The communication method of the communication unit 256 may be wired or wireless, and for example, a wired LAN, a wireless LAN, Wi-Fi, Bluetooth, or the like is used. Furthermore, the communication unit 256 may support two or more types of communication methods. Furthermore, the communication unit 256 may perform communication between the information processing apparatus 111 and the controller device 113 using different communication methods.

The following is an example of processing of the information processing apparatus 111 using the XR application.

For example, the communication unit 205 receives input information indicating at least one of a state of the terminal device 112, a state around the terminal device 112, a state of the user, a behavior of the user, and an operation input to the input device 113 from the controller device 113 via the terminal device 112 or the terminal device 112, and supplies the input information to the control unit 221. The control unit 221 executes the XR application on the basis of the input information, generates output information for controlling display of a virtual object including CAD information regarding CAD in the XR space, and outputs the output information to the terminal device 112. The communication unit 205 transmits the output information to the terminal device 112.

Furthermore, for example, the control unit 221 executes the XR application and outputs output information indicating a change or abnormality in the state of the XR application to the terminal device 112 or the controller device 113. The communication unit 205 transmits the output information to the terminal device 122 or to the controller device 113 via the terminal device 112.

On the other hand, for example, the terminal device 112 notifies a change or abnormality in the state of the XR application by an image, a message, a voice, vibration, or the like on the basis of the output information. For example, the controller device 113 notifies a change or abnormality in the state of the XR application by vibration or the like on the basis of the output information.

Note that, hereinafter, in a case where each unit of the information processing apparatus 111 communicates with the outside via the communication unit 205, the description of the communication unit 205 may be omitted. For example, in a case where the space control unit 223 of the information processing apparatus 111 communicates with the terminal device 112 via the communication unit 205, it may be simply described that the space control unit 223 of the information processing apparatus 111 communicates with the terminal device 112.

Hereinafter, in a case where each unit of the terminal device 112 communicates with the outside via the communication unit 256, the description of the communication unit 256 may be omitted. For example, in a case where the control unit 253 of the terminal device 112 communicates with the information processing apparatus 111 via the communication unit 256, it may be simply described that the control unit 253 of the terminal device 112 communicates with the information processing apparatus 111.

For example, in the XR system 101, the space control unit 223 of the information processing apparatus 111 generates the display control information and transmits the display control information to the terminal device 112 via the communication unit 205, and the control unit 253 of the terminal device 112 receives the display control information via the communication unit 256 and controls the display unit 254 on the basis of the display control information. Hereinafter, the description of the series of processing may be simplified, and for example, description may be made such that the space control unit 223 of the information processing apparatus 111 controls the display unit 254 of the terminal device 112.

For example, in the XR system 101, the voice control unit 224 of the information processing apparatus 111 generates the voice control information and transmits the voice control information to the terminal device 112 via the communication unit 205, and the control unit 253 of the terminal device 112 receives the voice control information via the communication unit 256 and controls the voice output unit 255 on the basis of the voice control information. Hereinafter, the description of the series of processing is simplified, and for example, description may be made such that the voice control unit 224 of the information processing apparatus 111 controls the voice output unit 255 of the terminal device 112.

For example, in the XR system 101, the tactile sense presentation control unit 225 of the information processing apparatus 111 generates tactile control information and transmits the tactile control information to the controller device 113 via the communication unit 205 and the terminal device 112, and the controller device 113 presents a tactile stimulation on the basis of the tactile control information. Hereinafter, the description of the series of processing is simplified, and for example, description may be made such that the tactile sense presentation control unit 225 of the information processing apparatus 111 controls the controller device 113 via the terminal device 112.

<Configuration Example of Controller Device 113a>

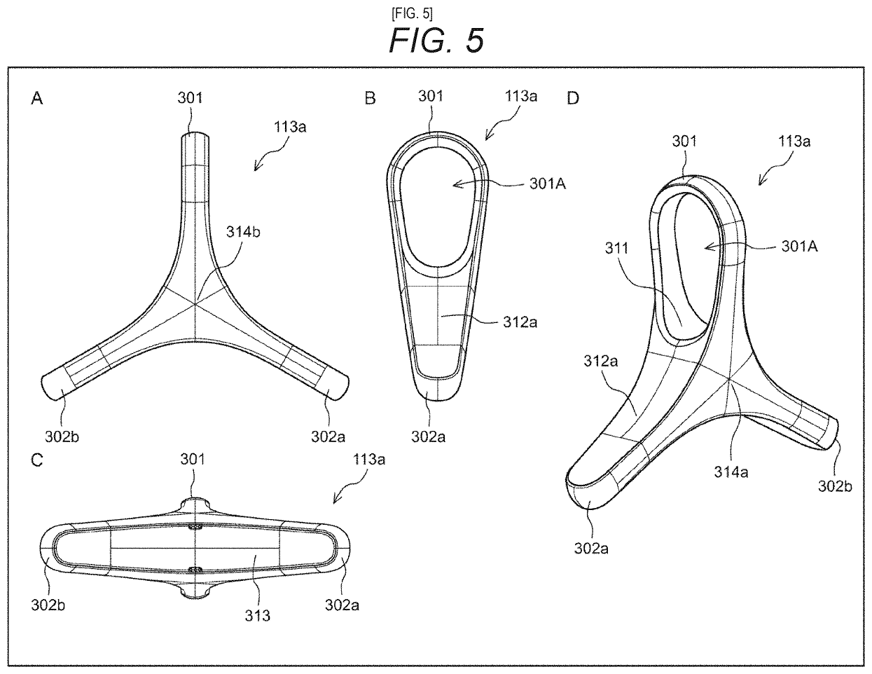

Next, a configuration example of the controller device 113a of FIG. 3 will be described with reference to FIGS. 5 to 14.

FIG. 5 illustrates a configuration example of the appearance of the controller device 113a. A of FIG. 5 is a left side view of the controller device 113a. B of FIG. 5 is a front view of the controller device 113a. C of FIG. 5 is a bottom view of the controller device 113a. D of FIG. 5 is a perspective view of the controller device 113a as viewed from diagonally front right.

Note that, hereinafter, the upward direction in A of FIG. 5 is defined as the upward direction of the controller device 113a, and the downward direction in A of FIG. 5 is defined as the downward direction of the controller device 113a. The right direction in A of FIG. 5 is defined as the front direction of the controller device 113a, and the left direction in A of FIG. 5 is defined as the rear direction of the controller device 113a.

The controller device 113a has a symmetrical shape as viewed from any of the front, rear, left, right, upper, and lower directions. In addition, in the controller device 113a, the shape of the front surface viewed from the front is similar to the shape of the rear surface viewed from the rear, and the shape of the right side surface viewed from the right direction is similar to the shape of the left side surface viewed from the left direction.

The controller device 113a is roughly divided into three parts of a ring portion 301, an operation portion 302a, and a holding portion 302b.

As illustrated in A of FIG. 5, the ring portion 301 extends in the upward direction from the vicinity of the center of gravity of a left side surface 314b. The operation portion 302a and the holding portion 302b have symmetrical shapes about the ring portion 301 as viewed from the direction of the side surface (for example, the left side surface 314b of the controller device 113a) of the ring portion 301. The operation portion 302a extends forward and in the obliquely downward direction from the vicinity of the center of gravity of the left side surface 314b (the vicinity of the lower end of the ring portion 301). The holding portion 302b extends rearward and in the obliquely downward direction from the vicinity of the center of gravity of the left side surface 314b (the vicinity of the lower end of the ring portion 301) in symmetry with the operation portion 302a. When the tip of the ring portion 301, the tip of the operation portion 302a, and the tip of the holding portion 302b are connected, an isosceles triangle having the tip of the ring portion 301 as a vertex is formed. The angle between the ring portion 301 and the operation portion 302a, the angle between the ring portion 301 and the holding portion 302b, and the angle between the operation portion 302a and the holding portion 302b are each about 120 degrees, and the above-described isosceles triangle is a substantially equilateral triangle.

The tip of the side surface of the ring portion 301 extends linearly, and the root extends in a curved shape. The tip of the side surface of the operation portion 302a extends linearly, and the root extends in a curved shape. The tip of the side surface of the holding portion 302b extends linearly, and the root extends in a curved shape. The boundary portion between the ring portion 301 and the operation portion 302a, the boundary portion between the ring portion 301 and the holding portion 302b, and the boundary portion between the operation portion 302a and the holding portion 302b are curved.

As illustrated in B of FIG. 5, a hole 301A penetrating in the front-rear direction is formed in the ring portion 301. The outer periphery of the ring portion 301 gently expands toward the tip, and the tip is curved. Similarly, the hole 301A spreads gently toward the tip, and the tip and the end are curved.

As illustrated in B of FIG. 5, the operation portion 302a is gradually thinned toward the tip, and the tip is curved. An upper surface 312a of the operation portion 302a is inclined forward and in the obliquely downward direction. On the upper surface 312a of the operation portion 302a, a shallow groove curved in the lateral direction and extending in the front-rear direction is formed. The tip of the upper surface 312a of the operation portion 302a is slightly recessed with respect to the tip of the operation portion 302a. As a result, the upper surface 312a of the operation portion 302a has a shape in which the inserted finger can be easily placed in a case where the user's finger is inserted into the hole 301A of the ring portion 301 in the front direction from the back.

The holding portion 302b has a shape similar to the operation portion 302a, and an upper surface 312b (not illustrated) having a shape similar to the upper surface 312a is formed.

As illustrated in C of FIG. 5, a bottom surface 313 curved in the front-rear direction is formed by the lower surface of the operation portion 302a and the lower surface of the holding portion 302b. A shallow groove curved in the lateral direction and extending in the front-rear direction is formed on the bottom surface 313.

A rubber-like material such as silicon or elastomer is used for the inner peripheral surface 311, the upper surface 312a, the upper surface 312b, and the bottom surface 313 of the controller device 113a, for example.

For other parts of the controller device 113a, for example, an IR transmissive resin is used.

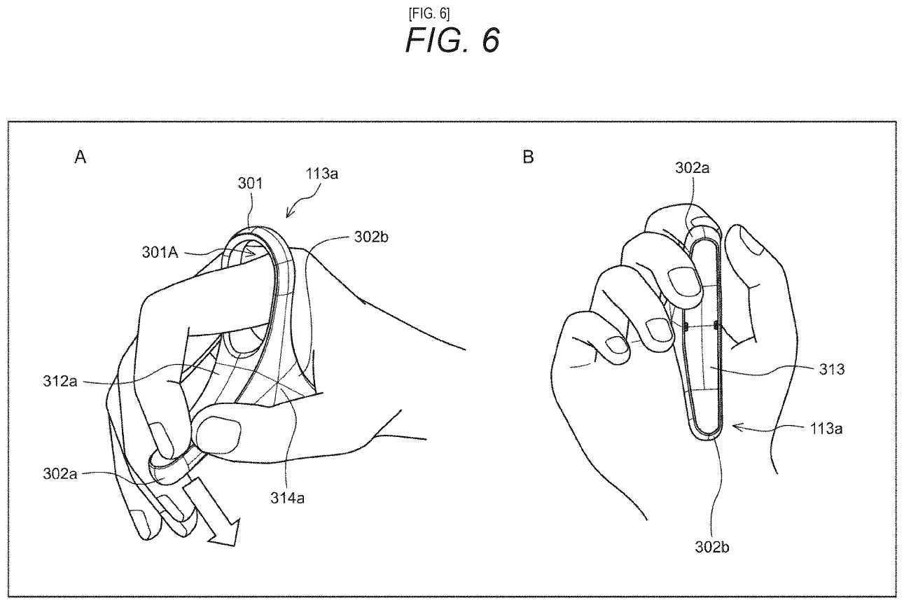

FIGS. 6 to 8 illustrate examples of a method of gripping the controller device 113a.

For example, as illustrated in A of FIG. 6, the index finger of the right hand is inserted into the ring portion 301 from the back to the front, the tip of the index finger is placed in the vicinity of the tip of the upper surface 312a of the operation portion 302a, and the operation portion 302a can be operated by the index finger. Since the size of the hole 301A of the ring portion 301 has a margin with respect to the thickness of the index finger, the index finger is easily inserted.

The tip of the thumb of the right hand is lightly placed in the vicinity of the tip of the side surface of the operation portion 302a, and the holding portion 302b is lightly gripped and held by the palm of the right hand.

For example, as indicated by an arrow in A of FIG. 6, in a case where the vicinity of the tip of the operation portion 302a is pressed in the downward direction by the index finger, the tip of the holding portion 302b abuts on the palm as illustrated in B of FIG. 6, whereby the controller device 113a is prevented from rotating in the pressing direction. As a result, the vicinity of the tip of the operation portion 302a is prevented from shaking in the space, and the user can reliably press the vicinity of the tip of the operation portion 302a in a state where the direction of the tip of the operation portion 302a is stable.

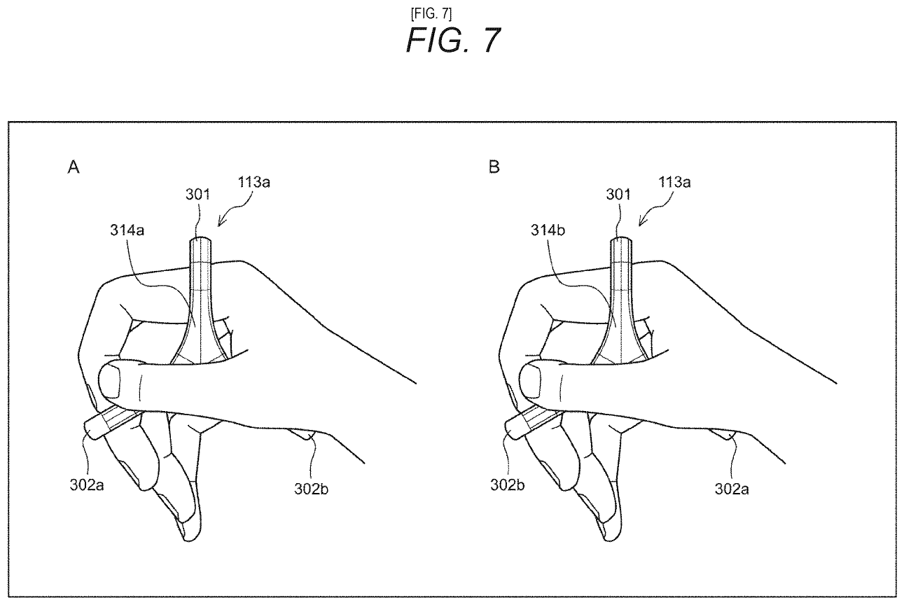

In addition, as described above, in the controller device 113a, the shape viewed from the front is similar to the shape viewed from the rear, and the shape viewed from the right direction is similar to the shape viewed from the left direction. Therefore, the user can hold the controller device 113a without worrying about the front and rear. That is, as illustrated in A of FIG. 7, the user can hold the controller device 113a such that the operation portion 302a faces the direction of the fingertip and the right side surface 314a faces the direction of the thumb. Furthermore, as illustrated in B of FIG. 7, the user can hold the controller device 113b such that the holding portion 302b faces the direction of the fingertip and the left side surface 314b faces the direction of the thumb.

Note that, hereinafter, as illustrated in A of FIG. 7, gripping the controller device 113a such that the operation portion 302a faces the direction of the fingertip is referred to as gripping the controller device 113a forward. Hereinafter, as illustrated in B of FIG. 7, gripping the controller device 113a such that the holding portion 302b faces the direction of the fingertip is referred to as holding the controller device 113a backward.

In a case where the controller device 113a is gripped backward, the roles of the operation portion 302a and the holding portion 302b are switched. That is, the holding portion 302b functions as an operation portion that can be operated by the index finger of the right hand, and the operation portion 302a functions as a holding portion that is held by the palm of the right hand.

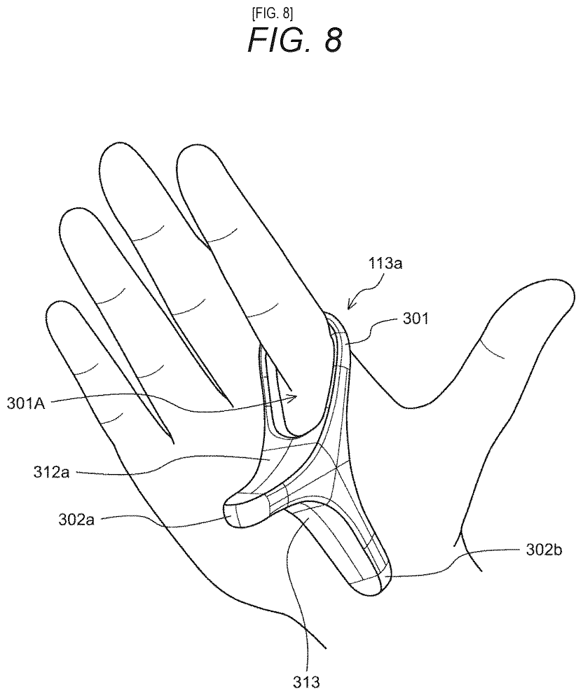

In addition, as illustrated in FIG. 8, even if the user releases the hand from the controller device 113a, the ring portion 301 is caught by the index finger, and the controller device 113a does not fall. This prevents the user from unexpectedly dropping the controller device 113a without providing a strap or the like.

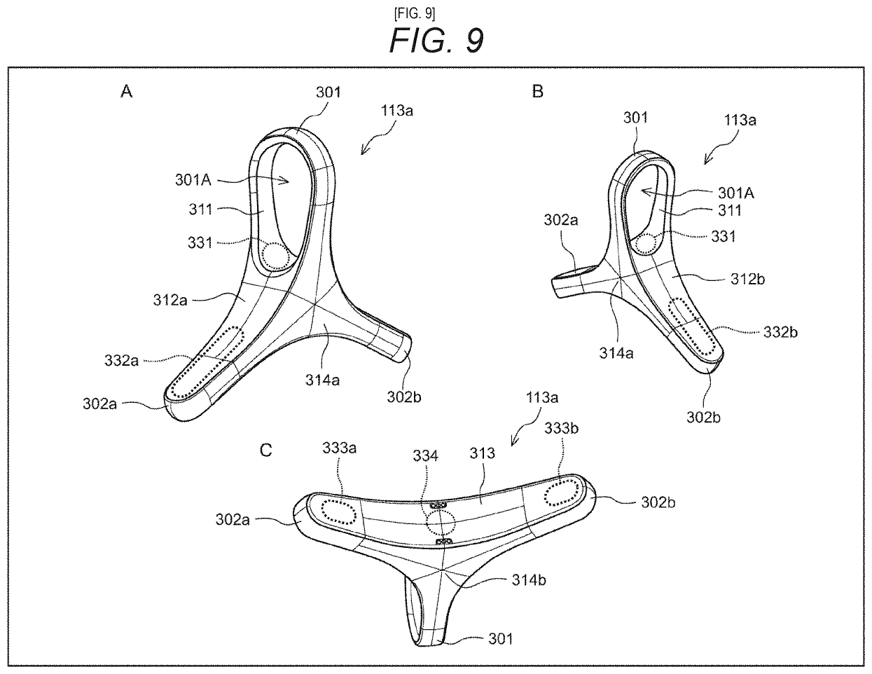

FIG. 9 illustrates an arrangement example of operation members of the controller device 113a. A of FIG. 9 is a perspective view of the controller device 113a as viewed from the obliquely upper right direction. B of FIG. 9 is a perspective view of the controller device 113a as viewed from the obliquely upper left direction. C of FIG. 9 is a perspective view of the controller device 113a as viewed from the rear obliquely downward direction.

The operation members are arranged symmetrically about the ring portion 301 in the front-rear direction and the left-right direction of the controller device 113a.

For example, the operation member 331 is arranged at the lower end portion of the inner peripheral surface 311 (hole 301A) of the ring portion 301. For example, the user bends the index finger and operates the operation member 331 with the fingertip of the index finger.

An operation member 332a is arranged in the vicinity of the tip of the upper surface 312a of the operation portion 302a. An operation member 332b is arranged in the vicinity of the tip of the upper surface 312b of the holding portion 302b. For example, the user operates the operation member 332a or the operation member 332b with the fingertip of the index finger.

The operation member 333a and the operation member 333b are arranged in the vicinity of the front end and the rear end of the bottom surface 313, respectively. For example, the user operates the operation member 333a or the operation member 333b with the fingertip of the ring finger or the little finger.

The operation member 334 is arranged at the center of the bottom surface 313 in the front-rear direction. For example, the user operates the operation member 334 with the fingertip of the thumb, the ring finger, or the little finger.

Any type of operation member such as a button, a touch pad, or a joystick can be used as the operation member 331, the operation member 332a, the operation member 332b, the operation member 333a, the operation member 333b, and the operation member 334. However, the same type of operation member is used for the operation member 332a and the operation member 332b arranged at symmetrical positions about the ring portion 301. Similarly, the same type of operation member is used for the operation member 333a and the operation member 333b arranged at symmetrical positions about the ring portion 301.

Any function can be assigned to the operation member 331, the operation member 332a, the operation member 332b, the operation member 333a, the operation member 333b, and the operation member 334, for example. However, similar functions are assigned to the operation member 332a and the operation member 332b arranged at symmetrical positions about the ring portion 301. Similarly, similar functions are assigned to the operation member 333a and the operation member 333b arranged at symmetrical positions about the ring portion 301.

Specifically, for example, a function of calling the main menu screen is assigned to the operation member 331. For example, a function of selecting a virtual object is assigned to the operation member 332a and the operation member 332b. For example, functions other than the selection functions of the operation member 332a and the operation member 332b are assigned to the operation member 333a and the operation member 333b. For example, a function of calling the sub menu screen is assigned to the operation member 334.

Note that, for example, different functions may be assigned to the operation member 332a and the operation member 332b, and the functions of both may be switched depending on the direction in which the controller device 113a is held. Similarly, for example, different functions may be assigned to the operation member 333a and the operation member 333b, and the functions of both may be switched depending on the direction in which the controller device 113a is held.

As described above, the user can perform a similar operation regardless of whether the user grips the controller device 113a in the forward or backward direction.

Note that, although it is assumed that an index finger is inserted into the ring portion 301, for example, a middle finger or a ring finger may be inserted and used.

Note that, hereinafter, in a case where it is not necessary to distinguish the operation member 332a and the operation member 332b from each other, they are simply referred to as the operation member 332. Hereinafter, in a case where it is not necessary to distinguish the operation member 333a and the operation member 333b from each other, they are simply referred to as the operation member 333.

### <Arrangement Example of Marker>

For example, a marker such as an IR light emitting element may be provided in the controller device 113a. Then, the recognition unit 221 of the information processing apparatus 111 may detect the marker of the controller device 113a on the basis of the image or the like sensed by the sensing unit 252 of the terminal device 112, and recognize the relative position and posture between the terminal device 112 and the controller device 113 on the basis of the position of the detected marker.

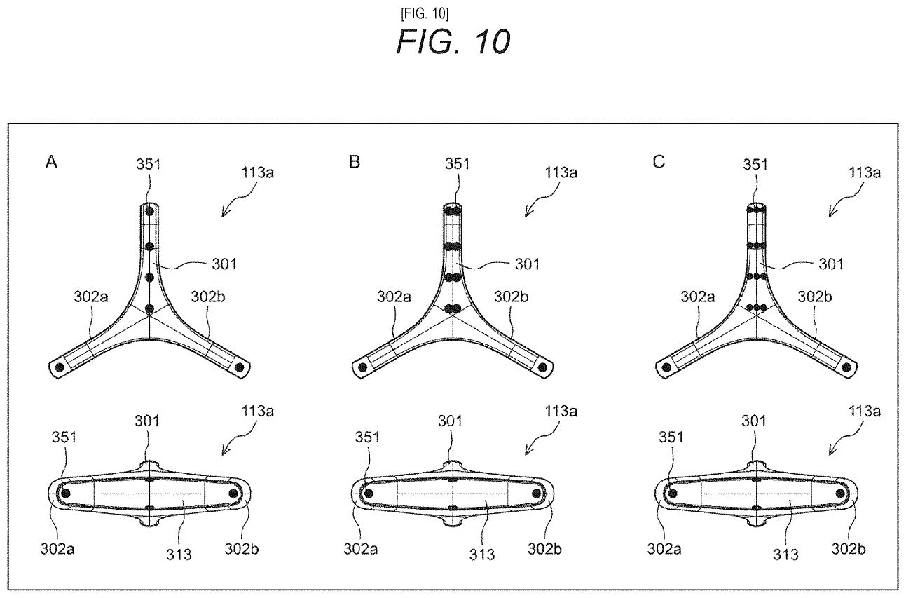

FIG. 10 illustrates arrangement examples of the markers 351 of the controller device 113a. Each marker 351 is indicated by a black circle.

For example, as illustrated in A of FIG. 10, the markers 351 are arranged in the vertical direction on the right side surface 314a and the left side surface 314b so as to surround the outer periphery of the ring portion 301. For example, the markers 351 are arranged in the vicinity of the tips of the both side surfaces of the operation portion 302a and in the vicinity of the tips of the both side surfaces of the holding portion 302b. For example, the markers 351 are arranged in the vicinity of the front end and the rear end of the bottom surface 313.

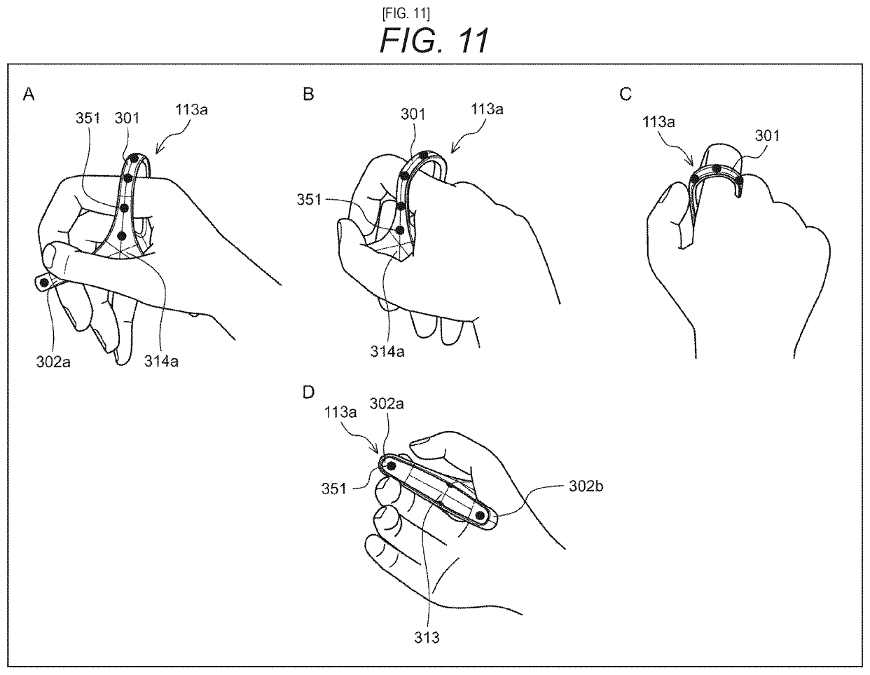

As a result, as illustrated in A to D of FIG. 11, at least some of the markers 351 becomes visible without being covered by the hand of the user in any posture of the controller device 113a.

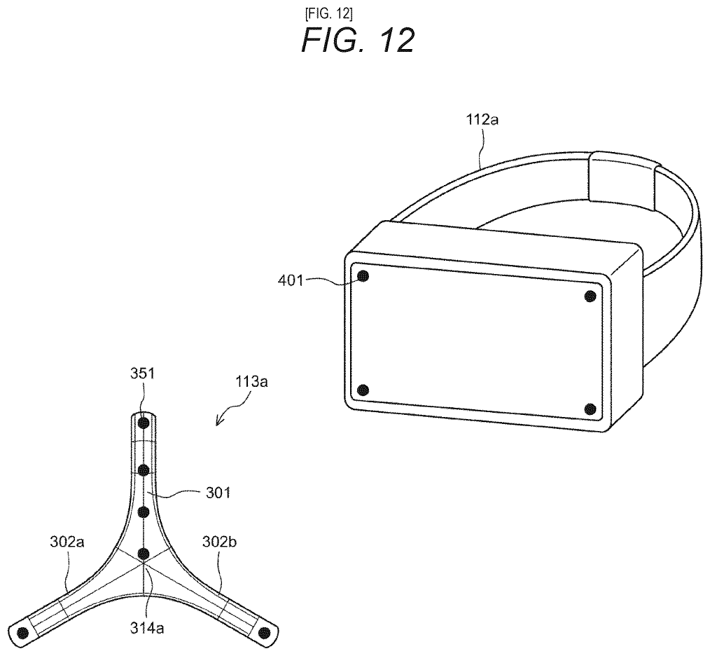

On the other hand, for example, as illustrated in FIG. 12, the terminal device 112 includes a plurality of cameras 401. Each camera 401 constitutes the sensing unit 252 (FIG. 4) of the terminal device 112. Each camera 401 captures an image of the controller device 113a. The terminal device 112 transmits sensing data including captured image data obtained by imaging to the information processing apparatus 111.

On the other hand, the control unit 202 of the information processing apparatus 111 receives the sensing data. The recognition unit 221 of the control unit 202 recognizes the position and posture of the controller device 113a with respect to the terminal device 112 on the basis of the light emission pattern of the markers 351 of the controller device 113a.

Note that, for example, as illustrated in B of FIG. 10, the markers 351 may be arranged in two rows in the lateral direction so as to surround the outer periphery of the ring portion 301. Furthermore, for example, as illustrated in C of FIG. 10, the markers 351 may be arranged in three rows in the lateral direction so as to surround the outer periphery of the ring portion 301.

In this manner, the controller device 113a can be downsized by disposing the markers 351 on the outer periphery of the ring portion 301.

<Example of Internal Structure of Controller Device 113a>

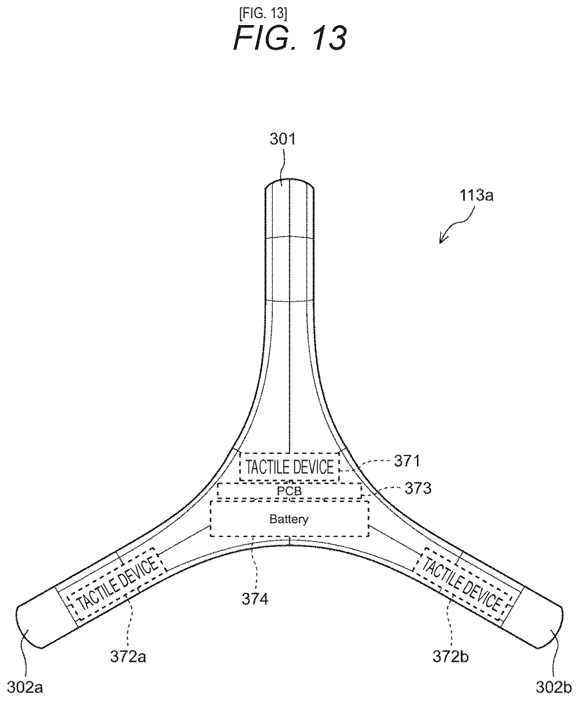

Next, an example of an internal structure of the controller device 113a will be described with reference to FIG. 13.

The controller device 113a incorporates a tactile device 371, a tactile device 372a, a tactile device 372b, a substrate 373, and a battery 374.

Each of the tactile device 371, the tactile device 372a, and the tactile device 372b includes, for example, a device that presents (transmits) a tactile stimulation such as vibration of a linear resonant actuator (LRA), an eccentric rotating mass (ERM), a piezoelectric element, or the like.

The tactile device 371 is arranged in the vicinity of the lower end of the inner peripheral surface 311 of the ring portion 301 (in the vicinity of the operation member 331 (FIG. 9)), and presents a tactile stimulation in the vicinity of the lower end of the inner peripheral surface 311.

The tactile device 372a is arranged in the vicinity of the tip in the operation portion 302a (in the vicinity of the operation member 332a (FIG. 9)), and transmits a tactile stimulation to the vicinity of the tip of the operation portion 302a.

The tactile device 372b is arranged in the vicinity of the tip in the holding portion 302b (in the vicinity of the operation member 332b (FIG. 9)), and transmits a tactile stimulation to the vicinity of the tip of the holding portion 302b.

The substrate 373 is a substrate for controlling the controller device 113a, and is arranged substantially at the center in the controller device 113a and below the tactile device 371.

The battery 374 is arranged below the substrate 373 in the controller device 113a and supplies power to each unit of the controller device 113a.

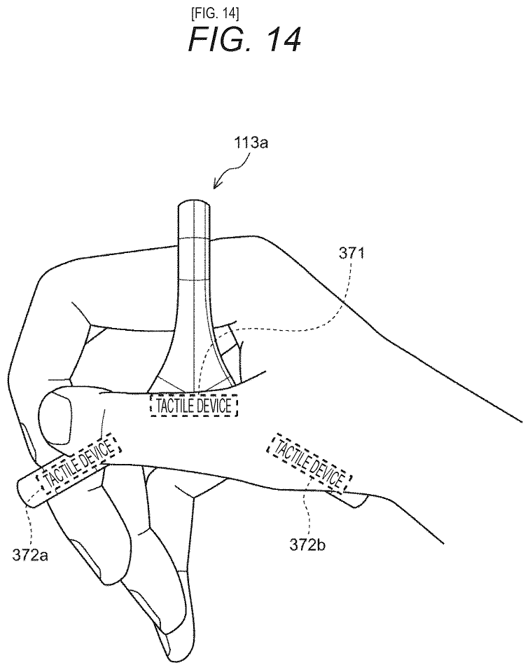

For example, as illustrated in FIG. 14, in a case where the controller device 113a is gripped forward by the right hand of the user, the tactile stimulation is presented in the vicinity of the base node of the thumb by the tactile device 371. The tactile stimulation is presented in the vicinity of the fingertip of the thumb and in the vicinity of the fingertip of the index finger by the tactile device 372a. The tactile stimulation is presented in the vicinity of the base of the thumb and the palm by the tactile device 372b.

Note that the tactile device 371, the tactile device 372a, and the tactile device 372b are arranged at symmetrical positions about the ring portion 301 in the front-back direction of the controller device 113a. Therefore, even if the user holds the controller device 113a in either the front or rear direction, similar tactile stimulation is presented to the hand of the user.

### <Processing of XR System 101>

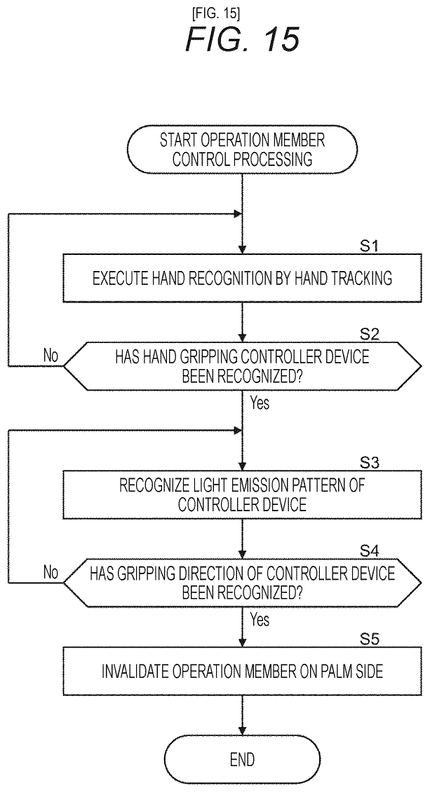

Next, processing of the XR system 101 will be described with reference to FIGS. 15 to 30.

### <Operation Member Control Processing>

First, operation member control processing executed by the XR system 101 will be described with reference to a flowchart of FIG. 15.

This processing is executed, for example, when the user holds or reholds the controller device 113a.

In step S1, the information processing apparatus 111 executes hand recognition by hand tracking.

For example, the control unit 253 of the terminal device 112 transmits sensing data including captured image data indicating an image captured by each camera 401 to the information processing apparatus 111.

On the other hand, the control unit 202 of the information processing apparatus 111 receives the sensing data. The recognition unit 221 of the control unit 202 executes hand recognition by hand tracking on the basis of the captured image data included in the sensing data. As a result, for example, the recognition unit 221 tracks the hand of the user gripping the controller device 113a on the basis of the markers 351 provided in the controller device 113a.

In step S2, the recognition unit 221 determines whether or not the hand gripping the controller device 113a is recognized on the basis of the result of the processing in step S1. In a case where it is determined that the hand gripping the controller device 113a is not recognized, the processing returns to step S1.

Thereafter, the processing of steps S1 and S2 is repeatedly executed until it is determined in step S2 that the hand gripping the controller device 113a is recognized.

On the other hand, in a case where it is determined in step S2 that the hand gripping the controller device 113a is recognized, the processing proceeds to step S3.

In step S3, the recognition unit 221 recognizes the light emission pattern of the controller device 113a on the basis of the captured image data. That is, the recognition unit 221 recognizes the light emission pattern of the marker 351 that is not hidden by the hand of the user in the controller device 113a.

In step S4, the recognition unit 221 determines whether or not the gripping direction of the controller device 113a has been recognized. Specifically, the recognition unit 221 attempts to recognize the gripping direction of the controller device 113a on the basis of the recognition result of the hand of the user gripping the controller device 113a and the recognition result of the light emission pattern of the controller device 113a. Then, in a case where it is determined that the gripping direction of the controller device 113a has not been recognized, the processing returns to step S3.

Thereafter, the processing of steps S3 and S4 is repeatedly executed until it is determined in step S4 that the gripping direction of the controller device 113a is recognized.

On the other hand, in a case where it is determined in step S4 that the gripping direction of the controller device 113a is recognized, the processing proceeds to step S5.

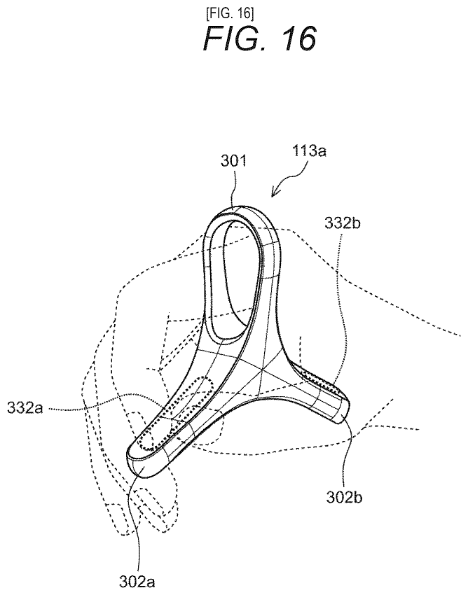

In step S5, the operation control unit 222 invalidates the operation member on the palm side. For example, as illustrated in FIG. 16, in a case where the controller device 113a is gripped forward, the operation member 332b on the palm side is disabled. Thereafter, for example, the recognition unit 221 and the operation control unit 222 ignore the operation input signal of the operation member 332b.

On the other hand, for example, in a case where the controller device 113a is gripped backward, the operation member 332a on the palm side is disabled.

Thereafter, the operation member control processing ends.

As a result, the operation member 332 is prevented from being erroneously operated by the palm of the user.

As described above, the hand gripping the controller device 113a and the gripping direction are recognized, and the operability of the controller device 113a does not change regardless of the gripping direction of the controller device 113a.

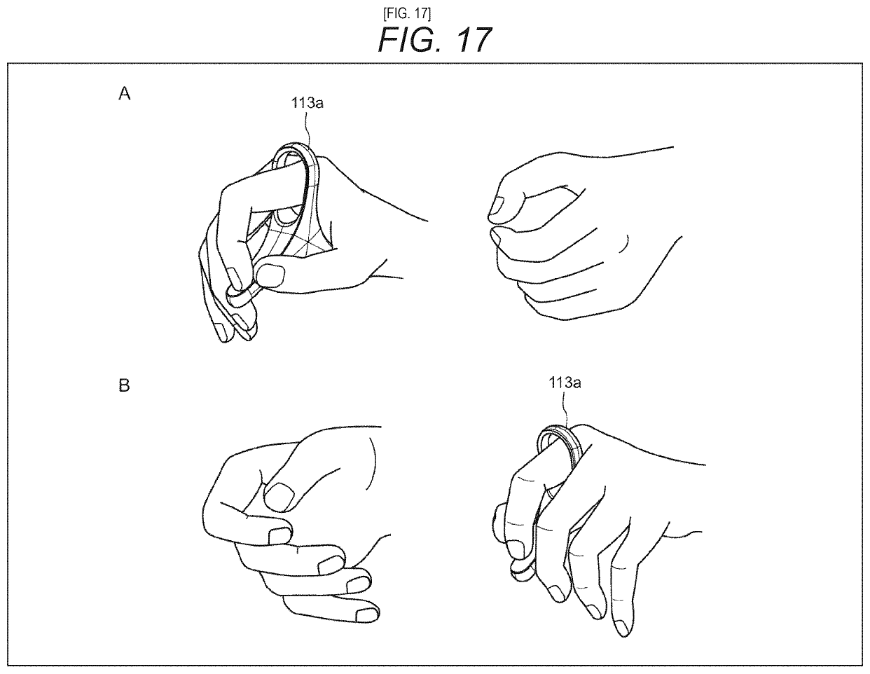

Therefore, for example, as illustrated in A and B of FIG. 17, even if no special setting is made on the terminal device 112 side, the user can use the controller device 113a gripped with the dominant hand regardless of the dominant hand of the user.

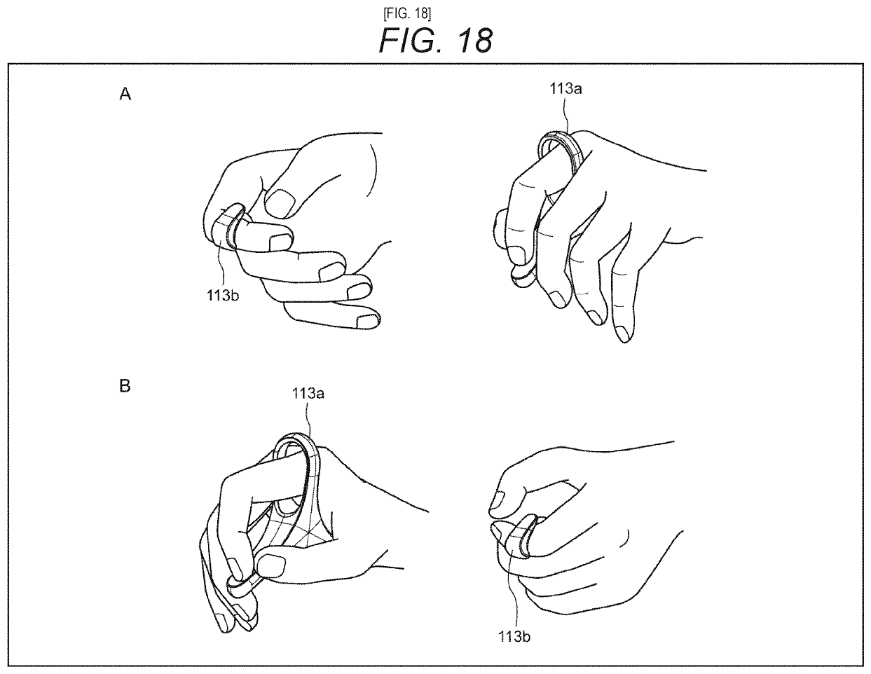

Note that, for example, as illustrated in A and B of FIG. 18, the user can wear another controller device 113b such as a ring-shaped device on the non-dominant hand side to use.

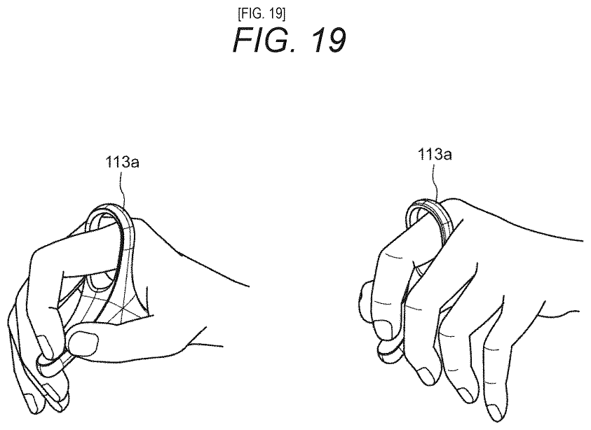

Furthermore, for example, as illustrated in FIG. 19, the user can wear and use the controller devices 113a with both hands.

### <Tactile Feedback Control Processing>

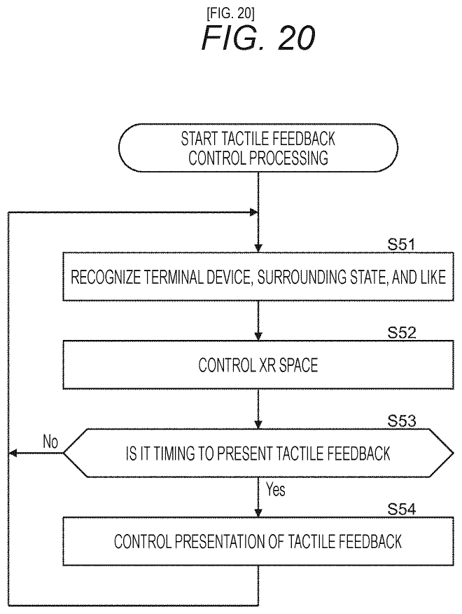

Next, tactile feedback control processing executed by the XR system 101 will be described with reference to a flowchart of FIG. 20.

This processing is started when the power of the information processing apparatus 111 is turned on, and ends when the power is turned off, for example.

In step S51, the information processing apparatus 111 recognizes the terminal device 112, the surrounding state, and the like.

Specifically, the sensing unit 252 of the terminal device 112 senses the state of the terminal device 112 and the state around the terminal device 112, and supplies sensing data indicating a sensing result to the control unit 253. The control unit 253 transmits the sensing data to the information processing apparatus 111.

On the other hand, the control unit 202 of the information processing apparatus 111 receives the sensing data.

The controller device 113a transmits a controller signal including an operation input signal indicating operation content for each operation member to the information processing apparatus 111 via the terminal device 112.

On the other hand, the control unit 202 of the information processing apparatus 111 receives the controller signal.

The recognition unit 221 of the control unit 202 recognizes the state of the terminal device 112, the state around the terminal device 112, the state of the controller device 113, the state of the user, the user operation, and the like on the basis of the sensing data and the controller signal. For example, the recognition unit 221 recognizes the position and posture of the terminal device 112. For example, the recognition unit 221 recognizes the line-of-sight direction of the user. For example, the recognition unit 221 recognizes the position and posture of the controller device 113a with respect to the terminal device 112. For example, the recognition unit 221 recognizes operation content for the controller device 113a.

In step S52, the space control unit 223 of the information processing apparatus 111 controls the XR space. Specifically, the space control unit 223 generates a virtual object to be displayed in the XR space on the basis of at least a part of the recognition result by the recognition unit 221, and performs various operations necessary for construction, display, and the like of the XR space such as behavior of the virtual object. The space control unit 223 generates display control information for controlling the display of the XR space on the basis of the calculation result and transmits the display control information to the terminal device 112 via the communication unit 205, thereby controlling the display of the XR space by the terminal device 112.

The recognition unit 221 recognizes the type, position, posture, and the like of the virtual object around the terminal device 112 (user) on the basis of the information and the like from the space control unit 223.

In step S53, the tactile sense presentation control unit 225 determines whether or not it is a timing to present tactile feedback on the basis of at least one of the recognition result by the recognition unit 221 and the information from the space control unit 223. In a case where it is determined that it is not the timing to present the tactile feedback, the processing returns to step S51.

Thereafter, the processing of steps S51 to S53 is repeatedly executed until it is determined in step S53 that it is the timing to present the tactile feedback.

On the other hand, in a case where it is determined in step S53 that it is the timing to present the tactile feedback, the processing proceeds to step S54.

In step S54, the information processing apparatus 111 controls presentation of tactile feedback. Specifically, the tactile sense presentation control unit 225 generates tactile control information for causing the controller device 113a to present a tactile stimulation. The tactile sense presentation control unit 225 transmits a tactile control signal to the controller device 113a via the terminal device 112.

On the other hand, the controller device 113a receives the tactile control information. Each tactile device of the controller device 113a presents a tactile stimulation on the basis of the tactile control information.

Thereafter, the processing returns to step S51, and the processing in and after step S51 is executed.

As described above, the tactile stimulation is appropriately presented to the user by the controller device 113a.

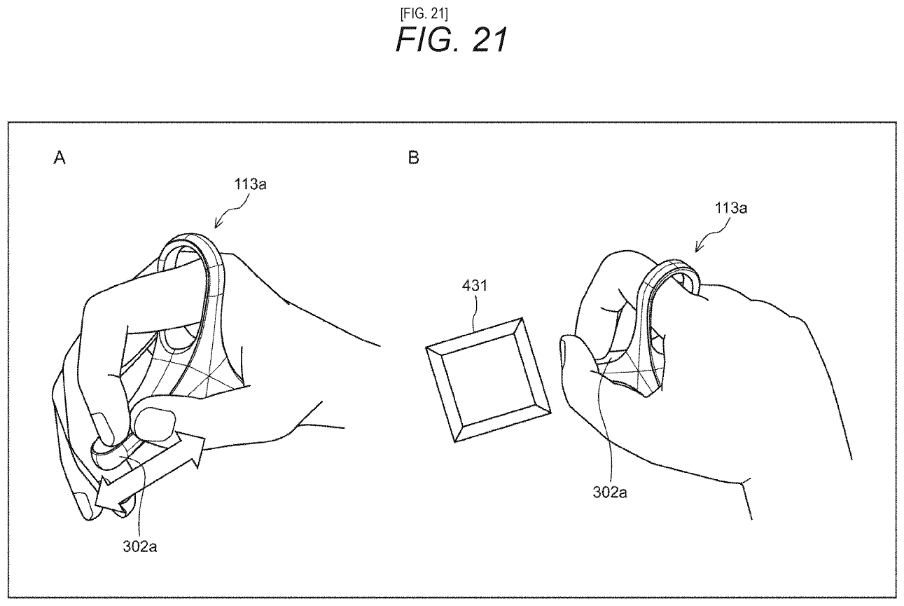

Here, an example of a method of presenting tactile feedback of the controller device 113a will be described with reference to FIGS. 21 to 23.

For example, in a case where the operation member 332a (FIG. 9) in the vicinity of the tip of the operation portion 302a of the controller device 113a includes a touch pad, and the operation member 332a is slid in the front-back direction by the fingertip of the index finger as illustrated in A of FIG. 21, a tactile stimulation is presented to the fingertip of the index finger by the tactile device 372a (FIG. 13) arranged in the vicinity of the operation member 332a.

For example, as illustrated in B of FIG. 21, in a case where the user touches the button 431 in the XR space with the tip of the operation portion 302a of the controller device 113a, a tactile stimulation is presented to the fingertip of the index finger by the tactile device 372a (FIG. 13).

For example, in a case where the controller device 113a or the hand gripping the controller device 113a collides with a virtual object in the XR space, an impact due to the collision is expressed using each tactile device of the controller device 113a.

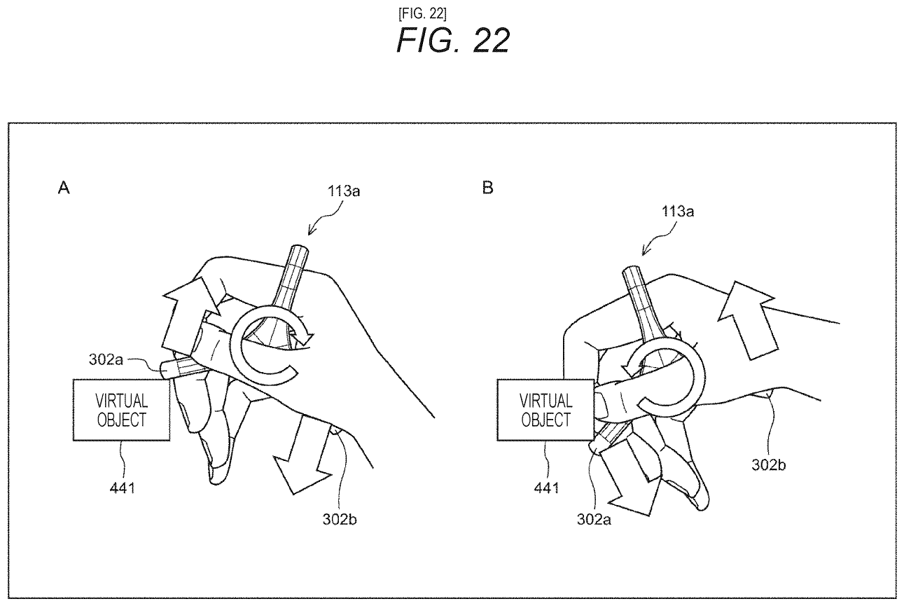

For example, A of FIG. 22 illustrates an example of a case where the tip of the operation portion 302a of the controller device 113a collides with the virtual object 441 in the XR space from the upward direction. In this case, for example, vibration in the upward direction is presented by the tactile device 372a (FIG. 13) in the vicinity of the tip of the operation portion 302a, and vibration in the downward direction is presented by the tactile device 372b (FIG. 13) in the vicinity of the tip of the holding portion 302b. As a result, it is possible to make the user feel the rotational force (moment) in the upward direction with respect to the controller device 113a.

For example, B of FIG. 22 illustrates an example of a case where the tip of the operation portion 302a of the controller device 113a collides with the virtual object 441 in the XR space from the downward direction. In this case, for example, vibration in the downward direction is presented by the tactile device 372a (FIG. 13) in the vicinity of the tip of the operation portion 302a, and vibration in the upward direction is presented by the tactile device 372b (FIG. 13) in the vicinity of the tip of the holding portion 302b. As a result, it is possible to make the user feel the rotational force (moment) in the downward direction with respect to the controller device 113a.

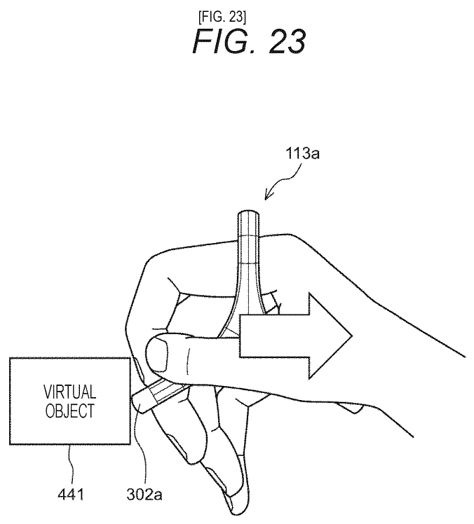

For example, FIG. 23 illustrates an example of a case where the tip of the operation portion 302a of the controller device 113a collides with the virtual object 441 in the XR space from the front. In this case, for example, the entire controller device 113a is vibrated by vibrating the tactile device 371 (FIG. 13) in the vicinity of the center of the controller device 113a. As a result, the user can feel the reaction force from the virtual object 441 to the controller device 113a.

As described above, the operability of the controller device 113a can be improved. As a result, the operability with respect to the XR space is improved.

### <Example of Method of Specifying Virtual Object>

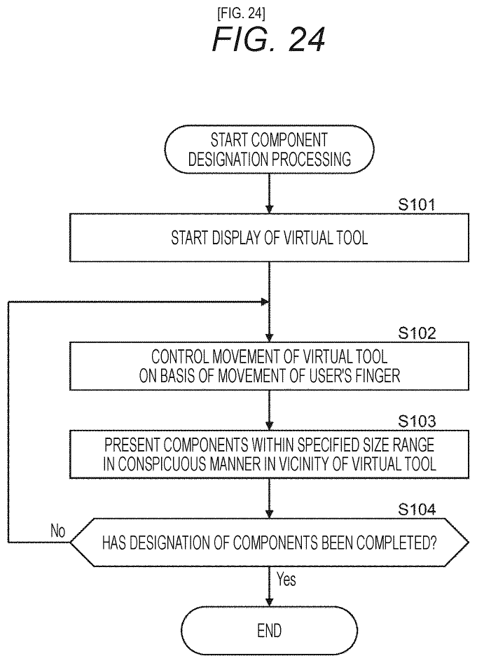

Next, an example of a method of designating a virtual object in the XR space in the XR system 101 will be described with reference to FIGS. 24 to 30. Specifically, an example of a case where a component that is a virtual object is designated in a case where a product or the like is designed by three-dimensional CAD in the XR system 101 will be described.

Note that, hereinafter, unless otherwise specified, the product and the component are assumed to be virtual objects in the XR space.

In addition, hereinafter, a virtual object designated by the user is referred to as a designated object, and a component designated by the user is referred to as a designated component.

### First Embodiment of Component Designation Processing

First, a first embodiment of component designation processing will be described with reference to a flowchart of FIG. 24.

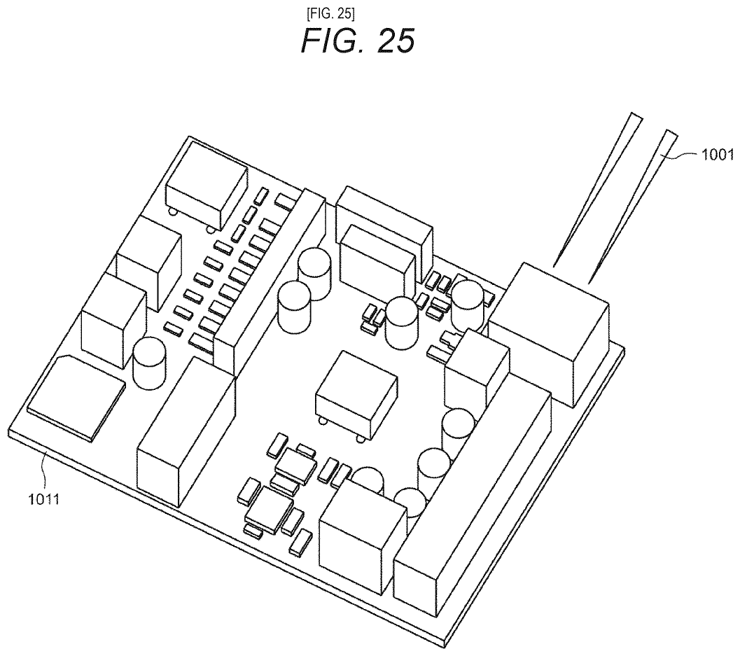

Hereinafter, as illustrated in FIG. 25, an example in which components on a three-dimensional virtual substrate 1011 are designated using a virtual tool 1001 in the XR space will be described.

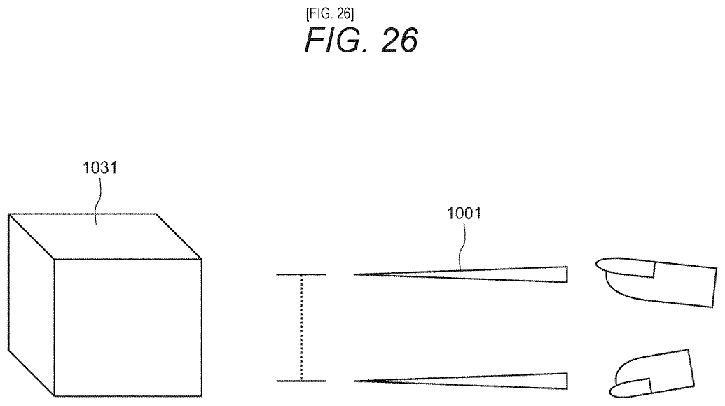

Furthermore, an example in which the user operates the virtual tool 1001 with the thumb and the index finger of one hand (hereinafter, referred to as a dominant hand) as illustrated in FIG. 26 will be described below.

The virtual tool 1001 is one of virtual objects displayed in the XR space, and is a tool capable of adjusting the degree of opening (interval between the tips) by opening and closing the tips like tweezers. For example, the user can adjust the position and posture of the virtual tool 1001 in the XR space by moving the thumb and the index finger of the dominant hand. Furthermore, for example, as illustrated in FIG. 26, the user can adjust the degree of opening of the virtual tool 1001 in the XR space by adjusting the interval (hereinafter, it is simply referred to as an interval between the thumb and the index finger) between the fingertip of the thumb and the fingertip of the index finger of the dominant hand. Then, as described later, the size of the component 1031 that can be designated changes according to the degree of opening of the virtual tool 1001.

Note that an example in which the degree of opening of the virtual tool 1001 changes in three stages of a large level, a medium level, and a small level will be described below.

This processing is started, for example, when an operation for shifting to the component designation state is performed. Note that the operation method for shifting to the component selection state is not particularly limited. For example, in a case where the user performs a predetermined operation on the controller device 113a or performs a predetermined gesture by hand, the state transitions to the component designation state.

In step S101, the XR system 101 starts display of the virtual tool 1001. Specifically, the space control unit 223 of the information processing apparatus 111 controls the display unit 254 of the terminal device 112 to start display of the virtual tool 1001 in the XR space.

In step S102, the XR system 101 controls the movement of the virtual tool 1001 on the basis of the movement of the user's finger.

For example, the sensing unit 252 of the terminal device 112 images a region including the thumb and the index finger of the dominant hand of the user, and supplies sensing data including the obtained captured image data to the control unit 253. The control unit 253 transmits the sensing data to the information processing apparatus 111.

On the other hand, the control unit 202 of the information processing apparatus 111 receives the sensing data. The recognition unit 221 of the control unit 202 recognizes the positions and postures of the thumb and the index finger of the dominant hand of the user with respect to the terminal device 112 on the basis of the sensing data.

The space control unit 223 calculates the position, posture, and degree of opening of the virtual tool 1001 in the XR space on the basis of the position and posture of the thumb and the index finger of the dominant hand of the user. The space control unit 223 controls the display unit 254 of the terminal device 112 on the basis of the calculation result to adjust the position, posture, and degree of opening of the virtual tool 1001 in the XR space.

In step S103, the XR system 101 presents components within a specified size range in a conspicuous manner in the vicinity of the virtual tool 1001.

For example, each component on the substrate 1011 is classified into three groups of a large size, a medium size, and a small size on the basis of the size of each component.

Note that the definition of the size of each component can be appropriately set.

For example, the maximum dimension of each component in the XR space may be set to the size of each component. Furthermore, for example, the size of each component may be changed according to the direction in which each component is designated by the virtual tool 1001. For example, in the case of a rectangular component, the length of the side designated by the virtual tool 1001 may be set as the size of the component.

The recognition unit 221 of the information processing apparatus 111 recognizes a component belonging to a group of a size designated by the degree of opening of the virtual tool 1001, in other words, a component satisfying a condition of a size designated by the degree of opening of the virtual tool 1001, among components existing in the vicinity of the tip of the virtual tool 1001 in the VR space, as a candidate (hereinafter, referred to as a designated component candidate) of the designated component.

Note that the vicinity of the tip of the virtual tool 1001 is set within a range of a predetermined distance from the tip of the virtual tool 1001 in a direction in which the tip of the virtual tool 1001 is directed, for example.

For example, in a case where the degree of opening of the virtual tool 1001 is at a small level, a small-sized component among components in the vicinity of the tip of the virtual tool 1001 is recognized as the designated component candidate. For example, in a case where the degree of opening of the virtual tool 1001 is at a medium level, a medium-size component among components in the vicinity of the tip of the virtual tool 1001 is recognized as the designated component candidate. For example, in a case where the degree of opening of the virtual tool 1001 is at a large level, a large-sized component among components in the vicinity of the tip of the virtual tool 1001 is recognized as the designated component candidate.

Next, the space control unit 223 of the information processing apparatus 111 controls the display unit 254 of the terminal device 112 to display, for example, the designated component candidate in a display mode different from other components in a conspicuous manner.

In this case, the display mode of any one of the designated component candidate and the other component may be changed, or both the display modes may be changed. For example, the designated component candidate may be highlighted by brightening the color of the designated component candidate or blinking the designated component candidate. For example, the components other than the designated component candidate may be made inconspicuous by darkening the color of the components other than the designated component candidate or making the components other than the designated component candidate translucent.

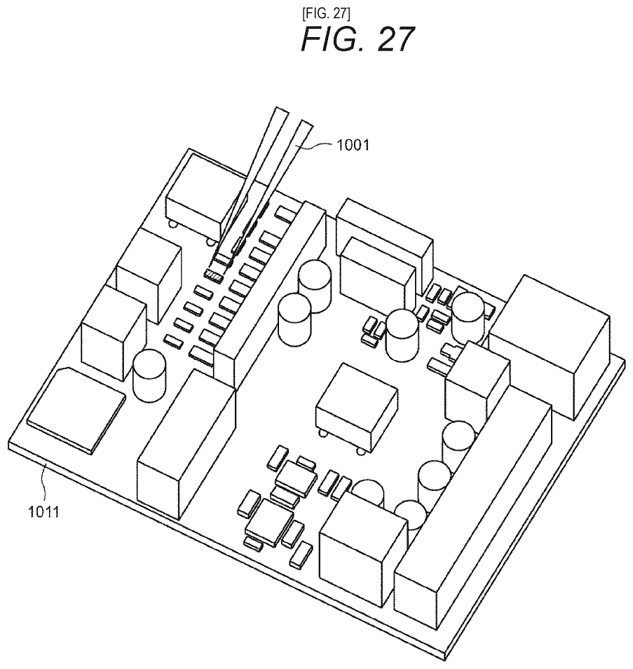

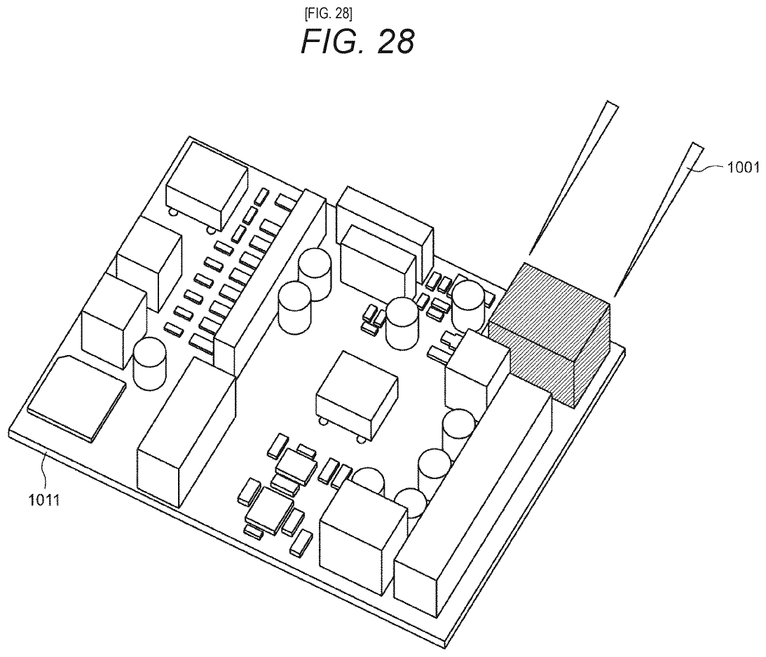

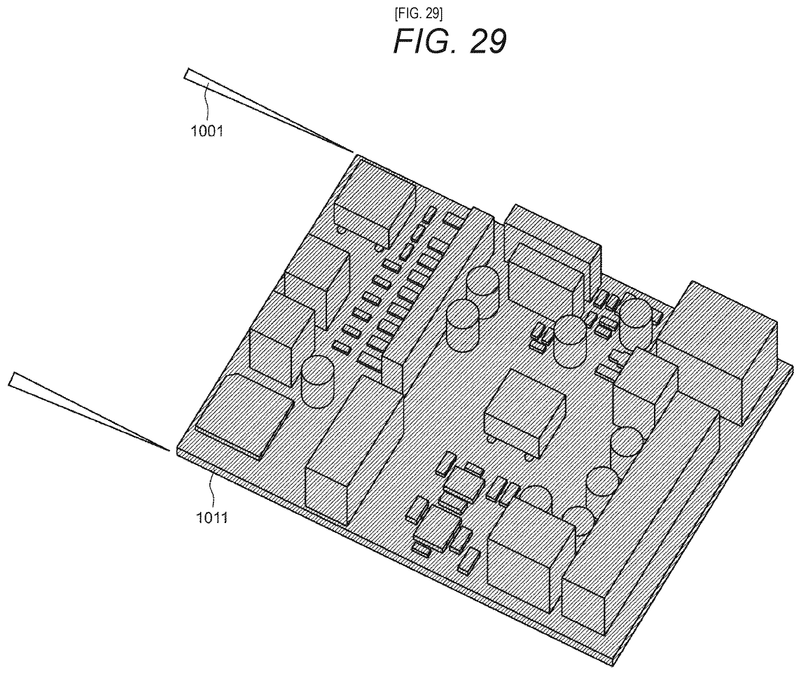

FIG. 27 illustrates an example in which the small-sized designated component candidate is highlighted in a case where the degree of opening of the virtual tool 1001 is at the small level. FIG. 28 illustrates an example in which the medium-sized designated component candidate is highlighted in a case where the degree of opening of the virtual tool 1001 is at the medium level. FIG. 29 illustrates an example in which the large-sized designated component candidate is highlighted in a case where the degree of opening of the virtual tool 1001 is at the large level.

Note that, in FIGS. 27 to 29, the designated component candidate is indicated by a hatched pattern.

In FIGS. 27 and 28, there is only one designated component candidate, and only one component is highlighted. In FIG. 29, there are a plurality of designated component candidates, and a plurality of components are highlighted. Note that, in a case where there is no designated component candidate, the component is not highlighted.

In step S104, the recognition unit 221 of the information processing apparatus 111 determines whether or not designation of components has been completed.

For example, the user can select the designated component from the designated component candidates by sandwiching the component with the virtual tool 1001 in a state where the tip of the virtual tool 1001 is in contact with a desired component using the thumb and the index finger of the dominant hand.

On the other hand, in a case where the recognition unit 221 does not recognize the operation of selecting the designated component from the designated component candidates, it is determined that the designation of the component is not completed, and the processing returns to step S102.

Thereafter, the processing of steps S102 to S104 is repeatedly executed until it is determined in step S104 that the designation of the component is completed.

On the other hand, in step S104, in a case where the recognition unit 221 recognizes the operation of selecting the designated component from the designated component candidates, it is determined that the designation of the component is completed, and the component designation processing ends.

### Second Embodiment of Component Designation Processing

Note that, although the example in which the virtual tool 1001 is operated by the user's finger has been described above, the virtual tool 1001 may be operated by the controller device 113a.

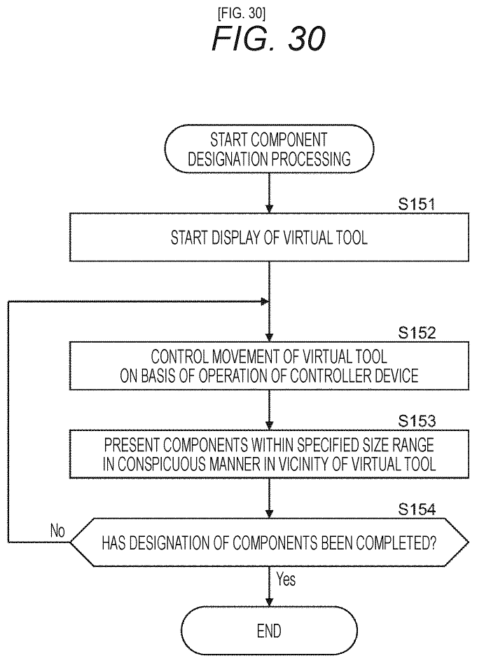

Here, a component designation processing (second embodiment of the component designation process) in a case where the virtual tool 1001 is operated by the controller device 113a will be described with reference to the flowchart of FIG. 30.

This processing is started, for example, when an operation for shifting to the component designation state is performed.

In step S151, the display of the virtual tool 1001 is started similarly to the processing in step S101 in FIG. 24.

In step S152, the XR system 101 controls the movement of the virtual tool 1001 on the basis of the operation of the controller device 113a.

Specifically, the controller device 113a transmits a controller signal including an operation input signal to the information processing apparatus 111 via the terminal device 112.

On the other hand, the control unit 202 of the information processing apparatus 111 receives the controller signal. The recognition unit 221 of the control unit 202 recognizes operation content for the controller device 113a on the basis of the operation input signal.

Furthermore, the sensing unit 252 of the terminal device 112 captures an image of a region including the controller device 113a, and supplies sensing data including the obtained captured image data to the control unit 253. The control unit 253 transmits the sensing data to the information processing apparatus 111.

On the other hand, the control unit 202 of the information processing apparatus 111 receives the sensing data. The recognition unit 221 of the control unit 253 recognizes the position and posture of the controller device 113 with respect to the terminal device 112 on the basis of the sensing data.

The space control unit 223 of the control unit 202 calculates the degree of opening of the virtual tool 1001 in the XR space on the basis of the operation content with respect to the controller device 113a.

For example, in a case where the operation member 332 of the controller device 113a includes a pressure sensor, the space control unit 223 calculates the degree of opening of the virtual tool 1001 on the basis of the pressure applied to the operation member 332. For example, in a case where the pressure on the operation member 332 is at a weak level, the space control unit 223 sets the degree of opening of the virtual tool 1001 to a small level. For example, in a case where the pressure on the operation member 332 is at a medium level, the space control unit 223 sets the degree of opening of the virtual tool 1001 to a medium level. For example, in a case where the pressure on the operation member 332 is at a strong level, the space control unit 223 sets the degree of opening of the virtual tool 1001 to a large level.

Note that the level division of the pressure on the operation member 332 can be appropriately set.

In step S153, similarly to the processing in step S103 in FIG. 24, components within a designated size range are presented in a conspicuous manner in the vicinity of the virtual tool 1001.

In step S154, the recognition unit 221 of the information processing apparatus 111 determines whether or not designation of components has been completed.

For example, the user can select the designated component from the designated component candidates by moving the controller device 113a or operating the operation member 332 to sandwich the component with the virtual tool 1001 in a state where the tip of the virtual tool 1001 is in contact with the desired component.

On the other hand, in a case where the recognition unit 221 does not recognize the operation of selecting the designated component from the designated component candidates, it is determined that the designation of the component is not completed, and the processing returns to step S152.

Thereafter, the processing of steps S152 to S154 is repeatedly executed until it is determined in step S154 that the designation of the component is completed.

On the other hand, in step S154, in a case where the recognition unit 221 recognizes the operation of designating the designated component from the designated component candidates, it is determined that the designation of the component is completed, and the component designation processing ends.

As described above, the user can quickly and reliably designate a desired component from among a plurality of components in the XR space, and can execute desired processing (for example, editing, operation, and the like) on the designated component.

Note that, for example, in a case where there is only one designated component candidate, processing such as presentation and selection of the designated component candidate may be omitted, and the component may be immediately recognized as the designated component.

### 2. Modifications

Hereinafter, modifications of the above-described embodiments of the present technology will be described.

<Modification Regarding Controller Device 113a>

In the above description, an example has been described in which the controller device 113a can be gripped in either the front or rear direction. However, for example, the controller device 113a can be gripped only forward.

In this case, the operation portion 302a and the holding portion 302b do not necessarily have symmetrical shapes about the ring portion 301, and for example, the operation portion 302a and the holding portion 302b may have different shapes. Further, the operation member 332b and the operation member 333b of the holding portion 302b can be deleted.

For example, a material other than resin such as metal can be used for the controller device 113a.

### <Modification Regarding Sharing of Processing>

For example, a part of the processing of the information processing apparatus 111 may be executed by the terminal device 112.

For example, the terminal device 112 may execute all or part of the processing of the information processing unit 211 of the information processing apparatus 111. For example, the terminal device 112 may independently present the XR space without being controlled by the information processing apparatus 111. For example, the information processing apparatus 111 and the terminal device 112 may independently execute processing such as construction of the XR space in a shared manner.

### <Modification Regarding Method of Specifying Virtual Object>

Although the method of designating a component in three-dimensional CAD has been described above, the present technology is not particularly limited in terms of use, application, and the like, and can be applied to the entire situation of designating a virtual object in the XR space.

For example, the user may operate the virtual tool 1001 using the controller device 113 other than the controller device 113a described above.

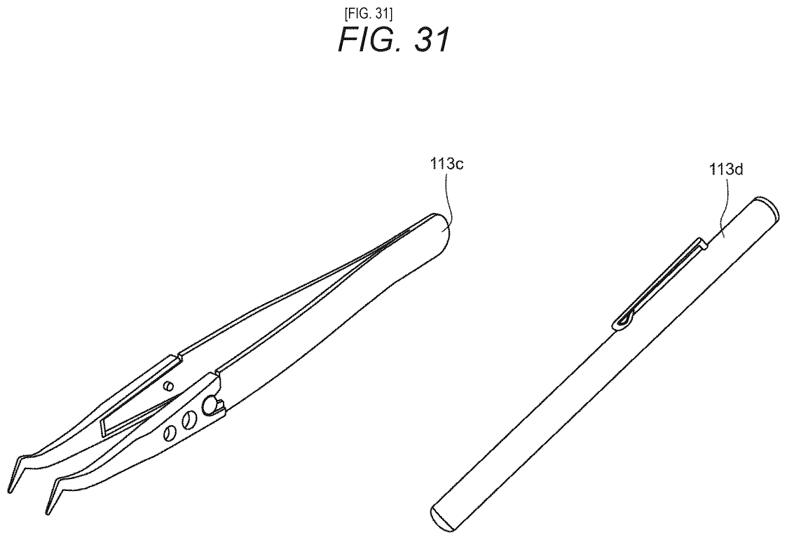

For example, a tweezers type controller device 113c and a pen type controller device 113d in FIG. 31 may be used.

For example, the controller device 113c can detect the interval (degree of opening) between the tips with a distance sensor or the like. Then, for example, the degree of opening of the virtual tool 1001 is controlled on the basis of the degree of opening of the controller device 113c.

For example, the controller device 113d includes a pressure sensor similarly to the controller device 113d, and the degree of opening of the virtual tool 1001 is controlled on the basis of the pressure applied to the controller device 113d.

Furthermore, for example, the virtual tool is not limited to the above-described example as long as the degree of opening of the tips can be adjusted. For example, a virtual tool that simulates not only the tip portion such as the virtual tool 1001 but also the entire tweezers may be used.

Note that the user may designate the virtual object by directly using the hand of the user or the controller device 113 instead of the virtual tool 1001. In this case, for example, an image obtained by imaging the hand of the user or the controller device 113 may be displayed in the XR space, or the hand of the user or the controller device 113 may directly enter the XR space.

For example, the size of the candidate for the target designated object may be adjusted by the user adjusting the interval between the fingertips of the two fingers. Furthermore, for example, the interval between the fingertips of the two fingers may be divided into a plurality of ranges, and the virtual object belonging to the group of the size corresponding to the range including the set interval between the fingertips may be recognized as the candidate of the designated object. For example, in a case where the interval between the fingertips is divided into three ranges of large, medium, and small, and the interval between the fingertips is included in the large range, a large-sized virtual object may be recognized as a candidate for the designated object. In a case where the interval between the fingertips is included in the medium range, a medium-sized virtual object may be recognized as a candidate for the designated object. In a case where the interval between the fingertips is included in the small range, a small-sized virtual object may be recognized as a candidate for the designated object.

For example, the size of the candidate for the target specification unit object may be adjusted by the user adjusting the degree of opening of the tweezers type controller device 113c. Furthermore, for example, similarly to the case of using two fingers, the degree of opening of the controller device 113c may be divided into a plurality of ranges, and a virtual object belonging to a group having a size corresponding to the range including the set degree of opening may be recognized as a candidate for the designated object.

Furthermore, in a case where the user designates the virtual object directly or by operating the virtual tool 1001 using the fingers, the combination of the two fingers is not particularly limited. For example, a combination other than the combination of the thumb and the index finger may be used. For example, a combination of fingers of different hands (for example, the index finger of the right hand and the index finger of the left hand) may be used.

For example, the learning unit 226 of the information processing apparatus 111 may learn the tendency of the degree of opening of the user's finger, the controller device 113, or the virtual tool 1001, and adjust the level classification of the degree of opening and the grouping of the size of the virtual object.

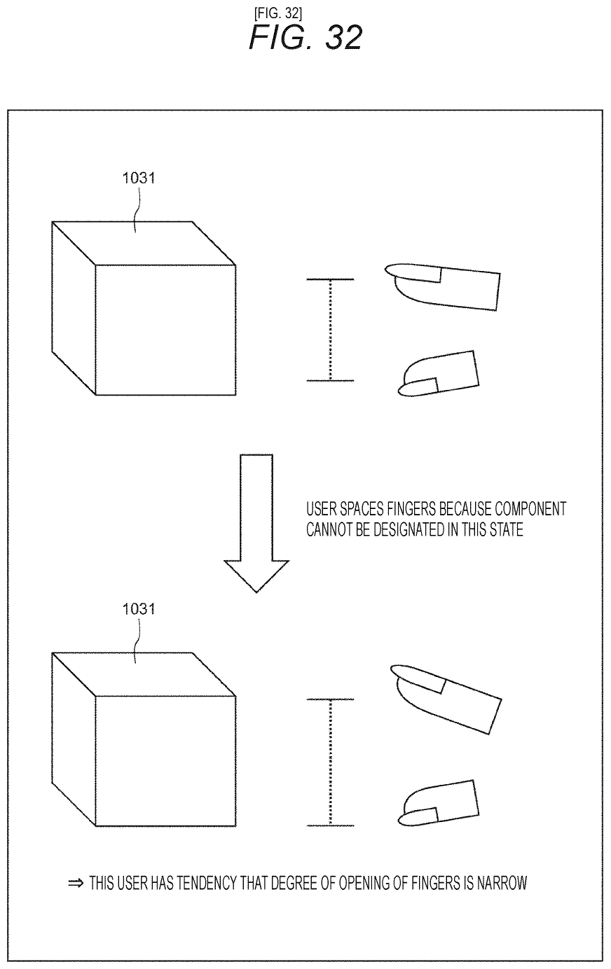

For example, as illustrated in FIG. 32, in a case where the degree of opening of the user's fingers tends to be narrow, for example, in a case where an operation of widening the fingers frequently occurs because the user cannot designate the component 1031 after widening the fingers narrowly with respect to the component 1031, the level classification of the degree of opening of the fingers may be set narrower than the standard. For example, in a case where the degree of opening of the fingers is classified into a small level, a medium level, and a large level, the boundary value between the small level and the medium level and the boundary value between the medium level and the large level may be set to be smaller than usual. As a result, for example, in a state where the degree of opening of the fingers is narrower than usual, it is recognized that the interval between the fingers is at a medium level or a large level. Therefore, in a state where the degree of opening of the fingers is narrower than usual, it is possible to designate a virtual object of a medium size or a large size.

Furthermore, in a case where a plurality of users works in the same XR space, each user may be allowed to independently designate a virtual object. In this case, the candidate for the designated object may be individually presented to each user on the basis of the degree of opening of the virtual tool 1001 or the like of each user.

As a result, for example, in a case where a certain user designs an outline of a product in a bird's eye view and another user performs fine component arrangement adjustment, each user can quickly designate a virtual object having a desired size.

Note that, in a case where a plurality of users performs work in the same XR space, messages, cautions, reviews, comments, and the like may be shared among the users in the XR space.

For example, in the XR space, a menu for selecting the designated object from the candidates for the designated object may be displayed, and the user may select the designated object from the menu. In this case, as described above, since the number of candidates for the designated object is narrowed down on the basis of the size and position of the virtual object, the number of menu selections is reduced, and the user can easily select the designated object.

The classification of the sizes of the virtual objects is not limited to the above-described three, and can be set to any number of two or more.

### Other Modifications

For example, the controller device 113a can be used not only for the XR space but also for operation of a two-dimensional space and a three-dimensional space such as a game.

### 3. Other

### <Configuration Example of Computer>

The above-described series of processing can be executed by hardware or software. In a case where the series of processing is executed by software, a program that configures the software is installed in a computer. Here, examples of the computer include a computer incorporated in dedicated hardware, and for example, a general-purpose personal computer that can execute various functions by installation of various programs.

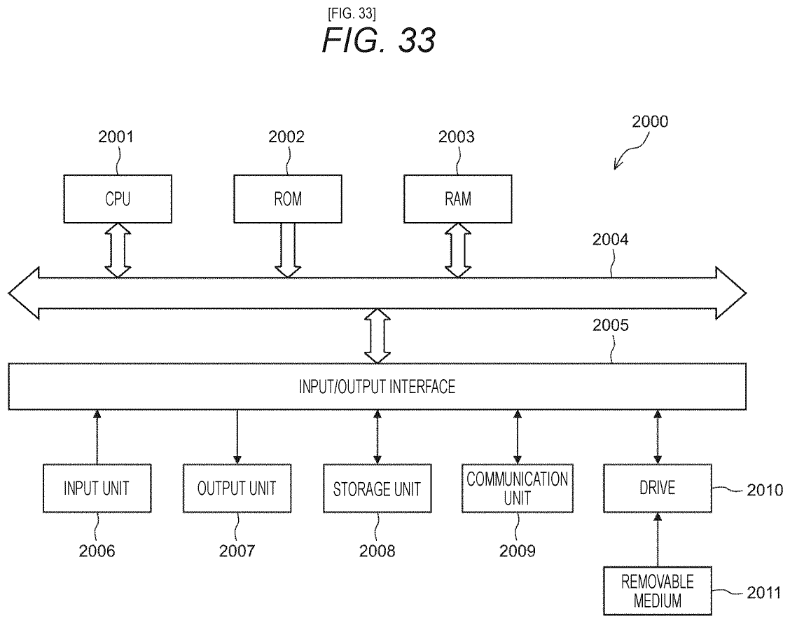

FIG. 33 is a block diagram illustrating a configuration example of hardware of the computer that executes the above-described series of processing by a program.

In a computer 2000, a central processing unit (CPU) 2001, a read only memory (ROM) 2002, and a random access memory (RAM) 2003 are mutually connected by a bus 2004.

An input/output interface 2005 is further connected to the bus 2004. An input unit 2006, an output unit 2007, a storage unit 2008, a communication unit 2009, and a drive 2010 are connected to the input/output interface 2005.

The input unit 2006 includes an input switch, a button, a microphone, an image sensor, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer 2000 configured as described above, for example, the CPU 2001 loads a program recorded in the storage unit 2008 into the RAM 2003 via the input/output interface 2005 and the bus 2004 and executes the program, whereby the above-described series of processing is performed.

The program executed by the computer 2000 (the CPU 2001) can be provided by being recorded on, for example, the removable medium 2011 as a package medium or the like. Furthermore, the program can be provided via a wired or wireless transmission medium such as a local area network, the Internet, or digital satellite broadcasting.

In the computer 2000, the program can be installed in the storage unit 2008 via the input/output interface 2005 by attaching the removable medium 2011 to the drive 2010. Furthermore, the program can be received by the communication unit 2009 via a wired or wireless transmission medium and installed in the storage unit 2008. In addition to this, the program can be installed in the ROM 2002 or the storage unit 2008 in advance.

Note that the program executed by the computer may be a program that performs processing in a time series according to an order described in the present specification, or may be a program that performs processing in parallel or at necessary timing such as when a call is made.

Furthermore, in the present specification, the system means a set of a plurality of components (devices, modules (components), and the like), and it does not matter whether or not all the components are in the same housing. Thus, a plurality of devices housed in separate housings and connected to each other via a network and a single device including a plurality of modules housed in a single housing are both systems.

Moreover, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the flowchart described above can be performed by one device or can be performed by a plurality of devices in a shared manner.

Moreover, in a case where a plurality of pieces of processing is included in one step, the plurality of pieces of processing included in the one step can be executed by one device or executed by a plurality of devices in a shared manner.

### <Combination Example of Configuration>

The present technology can also have the following configurations.

(1)

An information processing apparatus includes:

a space control unit that controls display of a virtual object in an XR (cross reality) space; and

a recognition unit that recognizes a designated object that is the virtual object designated by a user on the basis of a position, a posture, and a degree of opening of a virtual tool or a real input device capable of adjusting a degree of opening of tips in the XR space.

(2)

The information processing apparatus according to (1), in which

the space control unit performs control to present a plurality of candidates in the XR space in a case where the plurality of candidates for the designated object is recognized by the recognition unit.

(3)

The information processing apparatus according to (2), in which

the space control unit controls to display the plurality of candidates in a display mode different from a display mode of another virtual object.

(4)

The information processing apparatus according to (3), in which

the recognition unit recognizes the candidate selected using the virtual tool or the input device as the designated object.

(5)

The information processing apparatus according to any one of (2) to (4), in which

the space control unit performs control to display a menu for selecting the designated object from the plurality of candidates in the XR space.

(6)

The information processing apparatus according to (5), in which

the recognition unit recognizes the candidate selected from the menu as the designated object.

(7)

The information processing apparatus according to any one of (2) to (6), in which

the recognition unit recognizes, as the candidate, the virtual object that satisfies a condition of a size designated by a degree of opening of the virtual tool or the input device among the virtual objects existing in a vicinity of a tip of the virtual tool or the input device.

(8)

The information processing apparatus according to any one of (1) to (7), in which

the space control unit adjusts a position, a posture, and a degree of opening of the virtual tool on the basis of a position, a posture, and an interval between fingertips of two fingers of a user.

(9)

The information processing apparatus according to any one of (1) to (7), in which

the space control unit adjusts a position, a posture, and a degree of opening of the virtual tool on the basis of a position, a posture, and an operation content of the input device.

(10)

The information processing apparatus according to (9), in which

the space control unit adjusts a degree of opening of the virtual tool on the basis of pressure applied to the input device.

(11)

The information processing apparatus according to (10), in which

the input device includes:

a ring portion into which a finger is inserted;

an operation portion operable by the finger inserted into the ring portion; and

a holding portion held by a palm in a case where the operation portion is operated by the finger, and

the space control unit adjusts a degree of opening of the virtual tool on the basis of pressure applied to the operation portion.

(11)

The information processing apparatus according to (9), in which

the space control unit adjusts a degree of opening of the virtual tool on the basis of a distance between tips of the input devices.

(12)

The information processing apparatus according to any one of (1) to (11), in which

the space control unit controls display of the virtual tool in the XR space.

(13)

The information processing apparatus according to any one of (1) to (9), in which

the input device is a tweezer type.

(14)

An information processing method includes, by an information processing apparatus:

controlling display of a virtual object in an XR space; and

recognizing a designated object that is the virtual object designated by a user on the basis of a position, a posture, and a degree of opening of a virtual tool or a real input device capable of adjusting a degree of opening of tips in the XR space.

Note that the effects described in the present specification are merely examples and are not limited, and other effects may be provided.

### Reference Signs List

101 XR system
111 Information processing apparatus
112 Terminal device
113, 113a to 113d Controller device
202 Control unit
203 Display unit
211 Information processing unit
221 Recognition unit
222 Operation control unit
223 Space control unit
224 Voice control unit
225 Tactile sense presentation control unit
226 Learning unit
252 Sensing unit
253 Control unit
254 Display unit
255 Voice output unit
301 Ring portion
301A Hole
302a Operation portion
302b Holding portion
312a, 312b Upper surface
313 Bottom surface
331 to 334 Operation member
351 Marker
371 to 372b Tactile device
401 Camera
1001 Virtual tool

1. An information processing apparatus comprising:
a space control unit that controls display of a virtual object in an XR (cross reality) space; and
a recognition unit that recognizes a designated object that is the virtual object designated by a user on a basis of a position, a posture, and a degree of opening of a virtual tool or a real input device capable of adjusting a degree of opening of tips in the XR space.

2. The information processing apparatus according to claim 1, wherein
the space control unit performs control to present a plurality of candidates in the XR space in a case where the plurality of candidates for the designated object is recognized by the recognition unit.

3. The information processing apparatus according to claim 2, wherein
the space control unit controls to display the plurality of candidates in a display mode different from a display mode of another virtual object.

4. The information processing apparatus according to claim 3, wherein
the recognition unit recognizes the candidate selected using the virtual tool or the input device as the designated object.

5. The information processing apparatus according to claim 2, wherein
the space control unit performs control to display a menu for selecting the designated object from the plurality of candidates in the XR space.

6. The information processing apparatus according to claim 5, wherein
the recognition unit recognizes the candidate selected from the menu as the designated object.

7. The information processing apparatus according to claim 2, wherein
the recognition unit recognizes, as the candidate, the virtual object that satisfies a condition of a size designated by a degree of opening of the virtual tool or the input device among the virtual objects existing in a vicinity of a tip of the virtual tool or the input device.

8. The information processing apparatus according to claim 1, wherein
the space control unit adjusts a position, a posture, and a degree of opening of the virtual tool on a basis of a position, a posture, and an interval between fingertips of two fingers of a user.

9. The information processing apparatus according to claim 1, wherein
the space control unit adjusts a position, a posture, and a degree of opening of the virtual tool on a basis of a position, a posture, and an operation content of the input device.

10. The information processing apparatus according to claim 9, wherein
the space control unit adjusts a degree of opening of the virtual tool on a basis of pressure applied to the input device.

11. The information processing apparatus according to claim 10, wherein
the input device includes:
a ring portion into which a finger is inserted;
an operation portion operable by the finger inserted into the ring portion; and
a holding portion held by a palm in a case where the operation portion is operated by the finger, and
the space control unit adjusts a degree of opening of the virtual tool on a basis of pressure applied to the operation portion.

12. The information processing apparatus according to claim 9, wherein
the space control unit adjusts a degree of opening of the virtual tool on a basis of a distance between tips of the input devices.

13. The information processing apparatus according to claim 1, wherein
the space control unit controls display of the virtual tool in the XR space.

14. The information processing apparatus according to claim 1, wherein
the input device is a tweezer type.

15. An information processing method comprising, by an information processing apparatus:
controlling display of a virtual object in an XR space; and
recognizing a designated object that is the virtual object designated by a user on a basis of a position, a posture, and a degree of opening of a virtual tool or a real input device capable of adjusting a degree of opening of tips in the XR space.
